(19) United States
(12) Patent Application Publication
(10) Pub. No.: US 2024/0159586 A1
(43) Pub. Date: May 16, 2024

(54) SYSTEM AND METHOD FOR PROVIDING AND/OR FACILITATING GIANT NONLINEAR OPTICAL RESPONSES FROM PHOTON AVALANCHING NANOPARTICLES

(71) Applicants: THE TRUSTEES OF COLUMBIA UNIVERSITY IN THE CITY OF NEW YORK, New York, NY (US); Korea Research Institute of Chemical Technology, DaeJeon (KR); The Regents of the University of California, Oakland, CA (US)

(72) Inventors: P. JAMES SCHUCK, New York, NY (US); CHANGHWAN LEE, New York, NY (US); EMMA XU, New York, NY (US); KAYUAN YAO, New York, NY (US); EMORY CHAN, Oakland, CA (US); BRUCE COHEN, San Francisco, CA (US); YUNG DOUG SUH, Seoul (KR); SANG HWAN NAM, Seoul (KR)

(21) Appl. No.: 18/531,271

(22) Filed: Dec. 6, 2023

Related U.S. Application Data
(63) Continuation of application No. 17/531,266, filed on Nov. 19, 2021.
(60) Provisional application No. 63/116,216, filed on Nov. 20, 2020.

(51) Int. Cl. G01J 1/42

(52) U.S. Cl. CPC G01J 1/42; G01J 2001/4466

(57) ABSTRACT

Exemplary nanoparticle and method for inducing photon avalanching using a nanoparticle can be provided. The nanoparticle can include, for example, at least 99% thulium doped nanocrystals of the nanoparticle. The nanoparticle can be composed of solely thulium. An atomic concentration of the thulium can be at least 8%. A near infrared excitation wavelength of the nanocrystals can be greater than about 1064 nm. The near infrared excitation wavelength can be between about 1400 nm to about 1490 nm. A passivated shell(s) can be included which can surround the nanocrystals.

### CROSS-REFERENCE TO RELATED APPLICATION(S)

This application relates to and claims priority from U.S. patent application Ser. No. 63/116,216, filed on Nov. 20, 2020, the entire disclosure of which is incorporated herein by reference.

### STATEMENT REGARDING FEDERALLY SPONSORED RESEARCH

This invention was made with government support under Grant Nos. DE-SC0019443 and DE-ACO2-02CH11231, awarded by the Department of Energy. The government has certain rights in the invention.

### FIELD OF THE DISCLOSURE

The present disclosure relates generally to nanoparticles, and more specifically, to exemplary embodiments of systems and method for providing and/or facilitating exemplary giant nonlinear optical responses from photon avalanching nanoparticles.

### BACKGROUND INFORMATION

One of several advantages of the use of photon avalanching (PA) can be its combination of extreme nonlinearity and efficiency, which can be achieved without any periodic structuring or interference effects. PA was first observed over 40 years ago in Pr³⁺-doped bulk crystals, which exhibited a sudden increase in upconverted luminescence when excited beyond a critical pump laser intensity (I_{P}). (See, e.g., Reference 3). Its discovery led to the development of other lanthanide-based bulk PA materials, utilized for example in efficient upconverted lasers (see, e.g., References 4-6 and 16), and its unique properties continue to spark interest over diverse fields. (See, e.g., References 6 and 7).

Thus, it may be beneficial to provide exemplary giant nonlinear optical responses from photon avalanching nanoparticles which can overcome at least some of the deficiencies described herein above.

### SUMMARY OF EXEMPLARY EMBODIMENTS

To that end, exemplary nanoparticle and method for inducing photon avalanching using a nanoparticle can be provided. The nanoparticle can include, for example, at least 99% thulium doped nanocrystals of the nanoparticle. The nanoparticle can be composed of solely thulium. An atomic concentration of the thulium can be at least 8%. A near infrared excitation wavelength of the nanocrystals can be greater than about 1064 nm. The near infrared excitation wavelength can be between about 1400 nm to about 1490 nm. A passivated shell(s) can be included which can surround the nanocrystals.

A passivated shell(s) can be included which can surround the nanocrystals. For example, a Yb³⁺ sensitizer can be omitted from the nanoparticle.

Additionally, an exemplary nanoparticle for inducing photon avalanching can include a plurality of nanocrystals, where a combined size of the nanocrystals can be less than about 100 nanometers in three-dimensional space. A near infrared excitation wavelength of the nanocrystals can be greater than about 1064 nm. The near infrared excitation wavelength can be between about 1400 nm to about 1490 nm. A passivated shell(s) can be included, which can surround the nanocrystals.

These and other objects, features and advantages of the exemplary embodiments of the present disclosure will become apparent upon reading the following detailed description of the exemplary embodiments of the present disclosure, when taken in conjunction with the appended paragraphs.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1A is a set of exemplary diagrams illustrating ore/shell avalanche nanoparticles (“ANPs”), with avalanching occurring when core Tm³⁺ concentration is ≥8% according to an exemplary embodiment of the present disclosure;

FIG. 1B is an exemplary graph illustrating emission intensity vs. excitation intensity according to an exemplary embodiment of the present disclosure;

FIG. 1C is an exemplary diagram of energy levels of the 4f¹² manifolds of Tm³⁺. R₁, R₂=ground- and excited-state excitation rates according to an exemplary embodiment of the present disclosure;

FIG. 2A is an exemplary graph illustrating 800 nm emission intensity vs. excitation intensity for ensemble films of 1%, 4%, and 8% Tm³⁺-doped nanocrystals according to an exemplary embodiment of the present disclosure;

FIG. 2B is an exemplary graph illustrating 800 nm emission rise times vs. excitation intensity for 8% Tm³⁺ ANPs according to an exemplary embodiment of the present disclosure;

FIG. 3A is a set of exemplary graphs illustrating 800 nm emission intensity vs. 1064 nm excitation intensity curves for different core sizes/shell thicknesses of 8% Tm³⁺-doped ANPs and ANPs with different Tm³⁺ concentrations according to an exemplary embodiment of the present disclosure;

FIG. 3B is an exemplary graph illustrating threshold intensity vs. W₂ extracted from the data in FIG. 3A according to an exemplary embodiment of the present disclosure;

FIG. 3C is an exemplary graph illustrating upconverting quantum yield according to an exemplary embodiment of the present disclosure;

FIG. 3D is an exemplary graph illustrating brightness vs. excitation intensity for 4%, 8%, and 20% Tm³⁺ according to an exemplary embodiment of the present disclosure;

FIGS. 4A and 4B are exemplary images of a single 8% Tm³⁺ ANP when excited according to an exemplary embodiment of the present disclosure;

FIG. 4C is an exemplary graph illustrating normalized intensity for FIGS. 4A and 4B according to an exemplary embodiment of the present disclosure;

FIGS. 4D and 4E are exemplary images produced using simulations of PASSI images for the same excitation intensities shown in FIGS. 4A and 4B according to an exemplary embodiment of the present disclosure;

FIG. 4F is an exemplary graph illustrating measured vs. simulated FWHMs of single-ANP PASSI images as a function of excitation intensity according to an exemplary embodiment of the present disclosure;

FIG. 4G is a set of exemplary PASSI images and a graph of 8% Tm³⁺ ANPs, separated by 300 nm, excited at decreasing intensities, from near saturation to near threshold according to an exemplary embodiment of the present disclosure;

FIG. 4H is a set of exemplary PASSI images and a graph of 8% Tm³⁺ ANPs produced using a simulation, separated by 300 nm, excited at decreasing intensities, from near saturation to near threshold according to an exemplary embodiment of the present disclosure;

FIG. 5 is a set of exemplary transmission electron micrographs of NaYF₄ 1%-100% Tm³ according to an exemplary embodiment of the present disclosure;

FIG. 6 is a set of exemplary transmission electron micrographs of NaYF₄ 1%-20% Tm³ according to an exemplary embodiment of the present disclosure;

FIG. 7 is an exemplary graph illustrating the determination of photon avalanche thresholds according to an exemplary embodiment of the present disclosure;

FIG. 8 is an exemplary graph illustrating increasing and decreasing excitation power scans for 8% Tm3+ doped nanocrystals according to an exemplary embodiment of the present disclosure;

FIG. 9 is an exemplary graph illustrating 800 nm emission intensity vs. 1064 nm excitation intensity curves for different core sizes/shell thicknesses of 1-100% Tm3+-doped ANP ensembles;

FIG. 10 is an exemplary diagram of a scanning confocal microscopy system coupled with time-correlated single photon counting electronics according to an exemplary embodiment of the present disclosure;

FIG. 11 is a set of exemplary graphs illustrating the evolution of time-resolved photoluminescence under 1064 nm excitation below and above the photon avalanche threshold;

FIG. 12 is an exemplary graph illustrating a comparison of time-resolved luminescence of the ³H₄-³H₆ transition (e.g., 800 nm) of NaYF₄:8% Tm 3+nanocrystal ensembles from DRE simulations and time-resolved luminescence measurements on ensembles according to an exemplary embodiment of the present disclosure;

FIG. 13 is an exemplary graph illustrating excitation vs. emission intensity curves on an 8% Tm³⁺ doped nanoparticle film for different excitation wavelengths in the NIR-II spectral window according to an exemplary embodiment of the present disclosure;

FIG. 14 is a set of sub-diffraction resolution images and graphs of data points fitted as Gaussian lineshapes according to an exemplary embodiment of the present disclosure;

FIG. 15A is an exemplary graph illustrating measured rise time vs. seed excitation intensity according to an exemplary embodiment of the present disclosure;

FIG. 15B is a set of exemplary graphs illustrating time-resolved luminescence depending on seed and illumination excitation intensities according to an exemplary embodiment of the present disclosure;

FIG. 16A is an exemplary hexagonal excitation pattern overlapped with an ANP phantom according to an exemplary embodiment of the present disclosure;

FIG. 16B is an exemplary luminescence image of only excited ANPs according to an exemplary embodiment of the present disclosure;

FIG. 17A is an exemplary diagram illustrating photon avalanching luminescence generation and ANP localization according to an exemplary embodiment of the present disclosure;

FIG. 17B is an exemplary hexagonal pattern being moved by pattern period divided by 5, to get 5×5=25 frames according to an exemplary embodiment of the present disclosure;

FIG. 17C is an exemplary localization image according to an exemplary embodiment of the present disclosure; and

FIG. 18 is an illustration of an exemplary block diagram of an exemplary system in accordance with certain exemplary embodiments of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

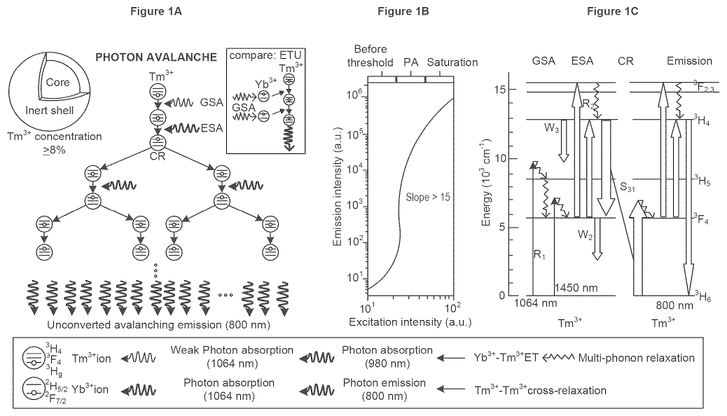

Photon avalanching can be a positive feedback system or method (see, e.g., Reference 6) that can be analogous to the second order phase transition of ferromagnetic spin systems, comparisons that have proven useful for modeling the process. (See, e.g., References 5 and 17). In lanthanide-based PA, a single ground-state absorption (“GSA”) event initiates a chain reaction of excited-state absorption (“ESA”) and cross-relaxation events between lanthanide (“Ln³⁺”) ions, resulting in the emission of many upconverted photons. (See e.g., FIG. 1A). The sensitivity of Ln³⁺ photophysics to local material properties has precluded the realization of PA in nanomaterials. Avalanche-like behavior in previous nanoparticle designs was ultimately the result of the formation of larger aggregate materials (see, e.g., Reference 18), non-PA thermal mechanisms (see, e.g., References 19 and 20), or of pre-avalanche energy-looping (“EL”) (see, e.g., References 6, 11, 13, and 21-27), with nonlinear order s ranging from 2-7 (e.g., s can be defined by I_{E}=I_{P}^{s} where I_{E} can be emission intensity). (See, e.g., References 7, 11, and 22). There remains strong motivation for developing PA in nanoparticles, as the ability to process these colloidal nanomaterials in solution facilitates them to be incorporated into varied device platforms, novel nanotechnologies, and unique environments (see, e.g., References 23 ad 28), using biocompatible surface chemistries (see, e.g., References 28-32). FIGS. 1A-1C show exemplary illustrations of photon avalanching mechanism in Tm³⁺-doped nanocrystals accordingly to an exemplary embodiment of the present disclosure. In particular, FIG. 1A illustrates an exemplary diagram of core/shell ANPs, with avalanching occurring when core Tm³⁺ concentration is ≥approximately 8% accordingly to an exemplary embodiment of the present disclosure. This exemplary embodiment indicates an exemplary ETU process, in which Yb³⁺ ions sensitize ground state absorption, precluding PA. FIG. 1B shows an exemplary model plot of emission intensity vs. excitation intensity, indicating the three (3) stages of PA behavior accordingly to exemplary embodiment of the present disclosure. FIG. 1C provides an exemplary illustration of exemplary energy levels of the 4f manifolds of Tm³⁺ according to an exemplary embodiment of the present disclosure. In this exemplary embodiment, R₁, R₂=ground- and excited-state excitation rates, respectively. W₂, W₃ can be the aggregate rates of relaxation from the ³F₄ and ³H₄ levels, respectively. These exemplary rates account for radiative and nonradiative relaxation pathways but may exclude cross-relaxation (CR) and other energy transfer processes. Additionally, in this exemplary embodiment, s₃₁ can equal or be substantially a CR rate.

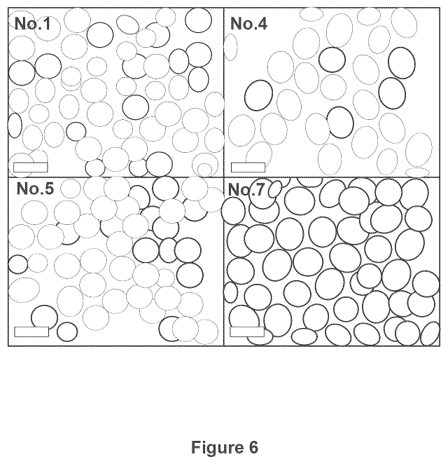

Exemplary nanocrystal design can be based on: 1) a design paradigm for upconverting nanoparticles (“UCNPs”) emphasizing high Ln³⁺ content and energy confinement (see, e.g., References 23, 29, and 33-37; 2) the choice of Tm³⁺ (see, e.g., FIG. 1A), with its slow intermediate-state decay rate W₂; 3) compositions that can omit sensitizers (see, e.g., Reference 22) (see, e.g., Yb³⁺ in FIGS. 1); and 4) the selection of NIR-II excitation wavelengths (e.g., either 1064 nm plus or minus about 10% or 1450 nm plus or minus about 10%; see FIGS. 1A-1C) optimized for resonant ESA, in contrast to the usual Tm³⁺ ground state pumping wavelengths (e.g., 800 nm, or 980 nm with Yb³⁺ sensitization; shown in FIGS. 1A-1C). (See, e.g., Reference 6, 11, 12, 21, and 38). These design specifications led to the synthesis of Tm³⁺-doped β-NaYF₄ core/shell structures 16-33 nm in total diameter (see, e.g., Reference 29 and 33) (see FIGS. 5 and 6; and Tables 1 and 2), which can be excited in the NIR-II region and emit in the NIR-I region at 800 nm. (See, e.g., Reference 22). The exemplary nanocrystals can have a combined size that can be less than about 100 nanometers in three-dimensional space (plus or minus about 10%).

FIG. 5 shows a set of exemplary transmission electron micrographs of representative NaYF₄: 1%-100% Tm³⁺@NaY_{0.8}Gd_{0.2}F₄ core-shell nanocrystals according to an exemplary embodiment of the present disclosure. Exemplary sizing details are provided in Tables 1 and 2. Scale bar=20 nm. FIG. 6 illustrates a set of exemplary transmission electron micrographs of representative NaYF₄:1%-20% Tm³⁺ cores, indicating that some of the cores are prolate in shape according to an exemplary embodiment of the present disclosure. In this example, the scale bar=about 20 nm.

To determine whether PA occurs, three definitive criteria were analyzed (see, e.g., References 5 and 6): (i) stronger pump-laser-induced ESA compared to GSA, with the ratio of ESA to GSA rates exceeding 10⁴ (R₂/R₁ shown in FIG. 1C) (see, e.g., Reference 22); (ii) a clear excitation power threshold, above which a large nonlinear increase in excited state population and emission can be observed; and (iii) a slowdown of the excited-state population rise-time at threshold. For PA, rise times can typically reach>100×the lifetime of the intermediate state, up to seconds. (See, e.g., Reference 6). Together, these criteria delineate PA from other nonlinear multiphoton processes, including conventional energy transfer upconversion (see, e.g., ETU, FIG. 1A inset) and energy looping. (See, e.g., Reference 22).

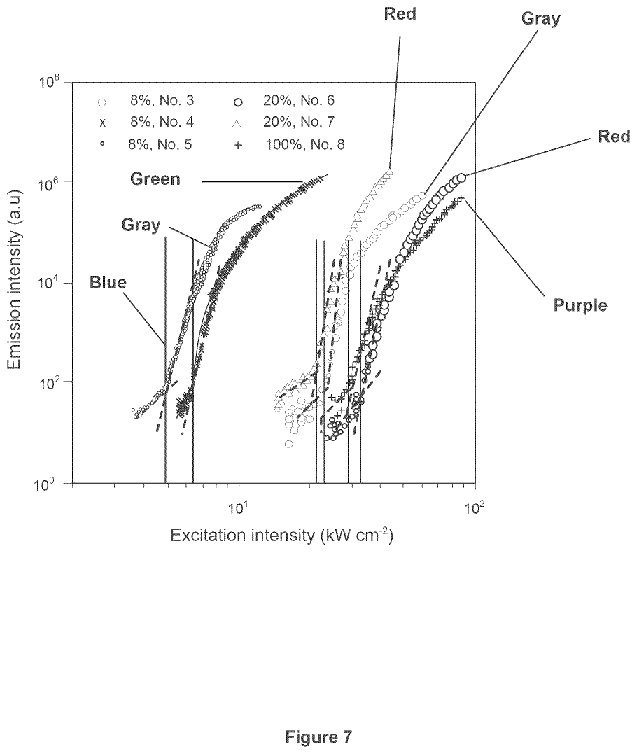

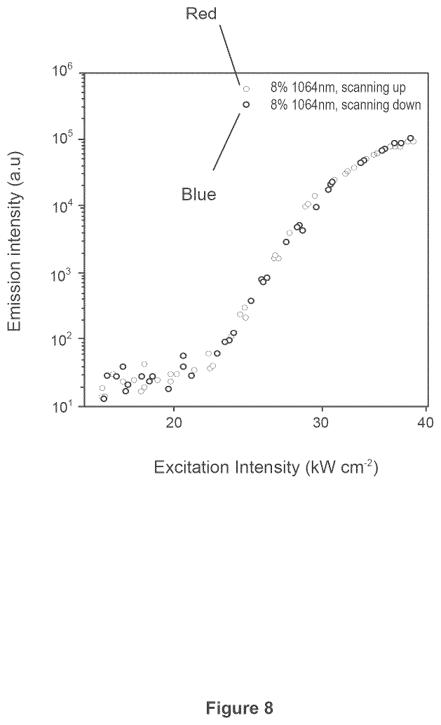

Plots of Tm³⁺ emission at 800 nm versus 1064 nm pump intensity measured on nanoparticle ensembles drop-casted onto glass substrates show that as Tm³⁺ content can be increased from 1% to 4%, the degree of nonlinearity s also increases, but resides firmly in the energy looping regime, with s≤7. (See, e.g., FIG. 2A). At these Tm³⁺ concentrations, the chain reaction of ESA and cross-relaxation can be too slow to compensate for radiative and multiphoton relaxation from the ³F₄ intermediate state, which occurs with rate W₂. However, at 8% Tm³⁺ doping, a clear threshold can be observed at pump intensity of ca. 20 kW cm⁻² (e.g., FIG. 7, Table 3), beyond which the combination of cross-relaxation and ESA act as a gain, and a nonlinear slope s>22 can be achieved (see, e.g., FIG. 2A, green circles), surpassing the maximum value of 7 observed in the existing pre-avalanching systems. Up- and down-scans of excitation intensity display no measurable photobleaching nor hysteresis, thus showing no significant contribution from excitation-induced thermal avalanching. (See e.g., FIG. 8). (See, e.g., Reference 39). Critically, all three PA criteria can be met at room temperature for these 8% Tm³⁺ ANPs. (See e.g., FIG. 2). FIG. 8 illustrates an exemplary graph showing increasing and decreasing excitation power scans for 8% Tm³⁺ doped nanocrystals according to an exemplary embodiment of the present disclosure. Hysteresis is not observed while scanning up and then down. 800 nm emission intensity vs. excitation intensity can be measured under 1064 nm excitation.

FIGS. 2A and 2B illustrate exemplary graphs providing an exemplary demonstration of nanoparticle photon avalanching according to an exemplary embodiment of the present disclosure. In particular, FIG. 2A illustrates an exemplary graph displaying about 800 nm emission intensity vs. excitation intensity for ensemble films of about 1% (orange 210), 4%, (blue 220) and 8% (brown 230) Tm³⁺-doped nanocrystals according to an exemplary embodiment of the present disclosure. In this exemplary embodiment, 1064 nm excitation is used, except where noted. (See, e.g., Tables 1 and 2 for ANP sizes). Photon avalanching can be achieved in the 8% Tm³⁺ ANPs with 1450 nm excitation (brown stars). The dash-dotted lines can be fits of the PA DRE model to the data. FIG. 2B shows an exemplary graph displaying 800 nm emission rise times vs. excitation intensity for 8% Tm³⁺ ANPs in (a), showing a large increase, up to 608 ms, near the PA threshold according to an exemplary embodiment of the present disclosure.

To understand why 8% Tm³⁺ doping gives rise to such non-linear emission, the PA process in ANPs was modelled using coupled nonlinear differential rate equations. (See e.g., DREs; Tables 4-8). (See, e.g., References 17 and 40). Fitting the model to the experimental data for 8% Tm³⁺ ANPs (see, e.g., FIG. 2A, grey dash-dotted line 240) yields an ESA-to-GSA rates (R₂/R₁) ratio of approximately 10,000 (e.g., Table 6), satisfying the R₂/R₁>10⁴ criterion for PA. (See, e.g., References 6 and 41).

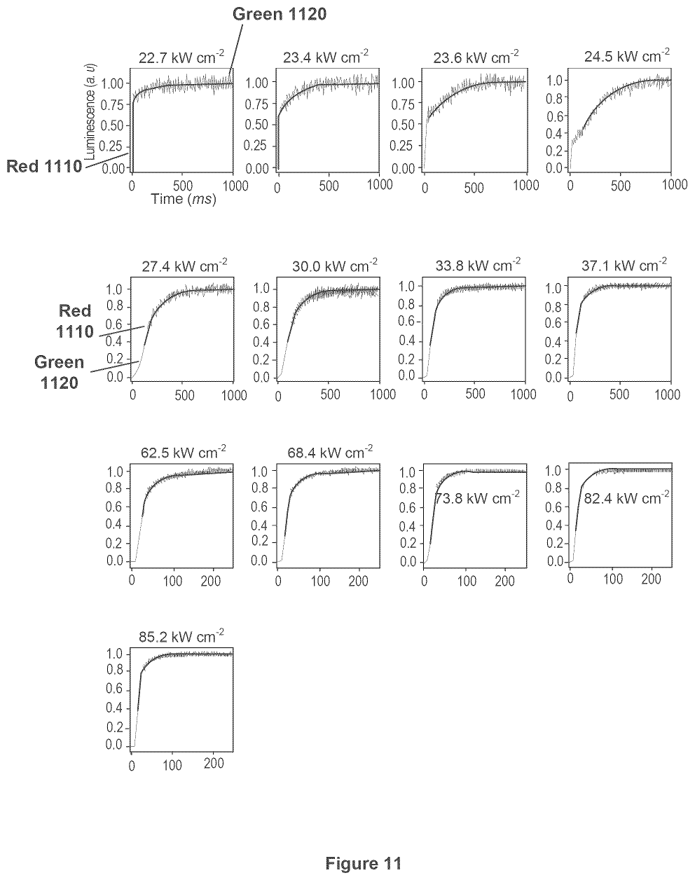

To observe the signature slow-down in excited-state population rise-times expected for PA (see, e.g., Reference 4, 6, 17 and 42), time-dependent luminescence from the Tm^{3+ 3}H₄ level (e.g., 800 nm emission) was measured. (See FIG. 2B and References 10-12). Rise time can be defined as the time needed to reach 95% of the asymptotic value. (See, e.g., FIG. 11). A significant delay of the luminescence rise-time emerges near the PA threshold intensity, reaching a maximum of approximately 608 ms (e.g., FIG. 2B)—nearly 400-fold the lifetime of the ³F₄ state—further verifying that the PA mechanism prevails in these nanoparticles.

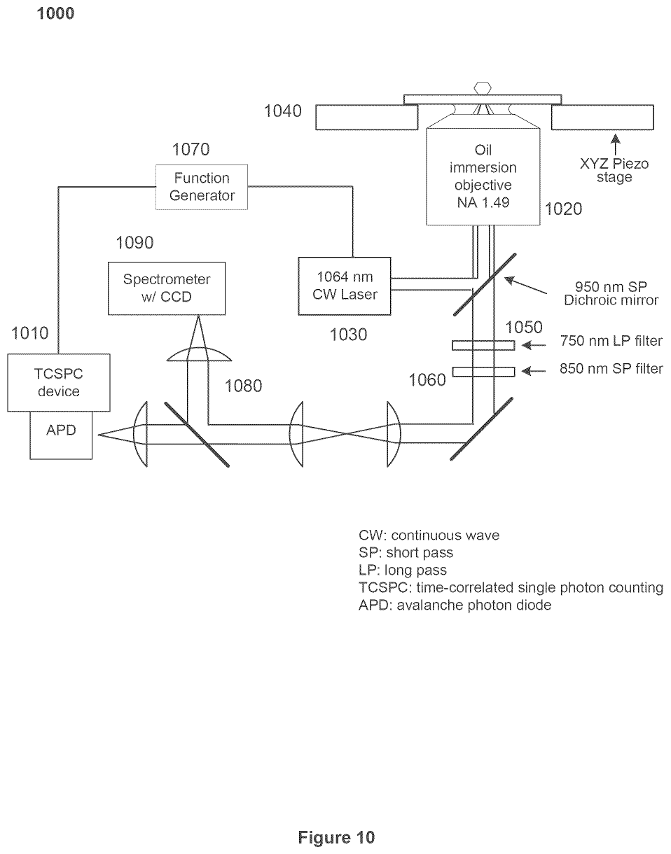

FIG. 10 shows an exemplary block diagram of the scanning confocal microscopy system 1000 provided with time-correlated single photon counting (TCSPC) electronics 1010, according to an exemplary embodiment of the present disclosure. The exemplary system 1000 also includes a microscope objective lens 1020 (shown as an exemplary oil immersion objective in FIG. 10), an excitation light source 1030 (shown as an exemplary laser with output wavelength 1064 nm in FIG. 10), a sample-scanning stage 1040, various exemplary wavelength specific optical filters, including shortpass (SP) filter 1050 and longpass (LP) filter 1060, a function generator 1070 for synchronizing optical excitation and collection, and exemplary optical detectors (which include single-photon detectors 1080 connected to TCSPC electronics and a charge-coupled-device (CCD) array 1090 coupled to a spectrometer, as shown in FIG. 10).

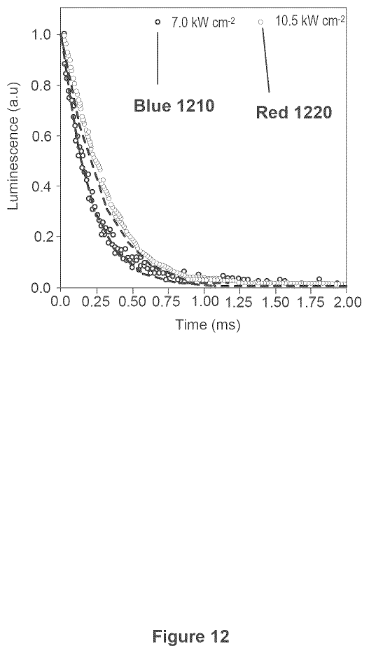

FIG. 11 illustrates a set of exemplary graphs showing evolution of time-resolved photoluminescence under 1064 nm excitation below and above the photon avalanche threshold according to an exemplary embodiment. The red or bright lines (1110) are exponential-fits of green lines/data points (1120). Rise time is determined by 95% of the asymptotic value. FIG. 12 shows an exemplary graph providing an exemplary comparison of time-resolved luminescence of the ³H₄-³H₆ transition (800 nm) of NaYF₄:8% Tm³⁺ nanocrystal ensembles from DRE simulations and time-resolved luminescence measurements on ensembles according to an exemplary embodiment. Blue dots (1210) refer to excitation intensity=about 7.0 kW cm⁻²; and Red dots (1220) refer to excitation intensity=about 10.5 kW cm⁻². Dashed lines are provided from the DRE simulations; and symbols are experimental data.

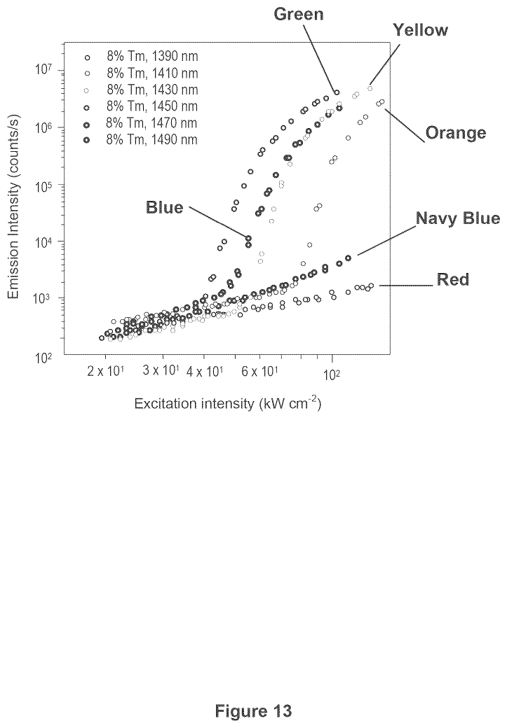

The exemplary modeling also predicts PA for even longer-wavelength excitation near 1450 nm, resonant with ESA between ³F₄ and ³H₄ but not with GSA. (See e.g., FIG. 1C). This can be a technologically attractive wavelength range as it can be beyond the absorption cutoff of Si-based detectors while leading to emission easily detected by Si, and can also be useful for deep-tissue imaging, including through-skull fluorescence imaging of live mouse brain at depths >2 mm. (See, e.g., Reference 43). Using 1450 nm excitation, PA, with the emission versus intensity curve showing a threshold at approximately 40 kW cm⁻² and maximum nonlinearity s=14.9 (e.g., FIG. 2A, brown stars) was observed. More generally, the ANPs demonstrate PA for wavelengths between 1400 nm and 1470 nm (e.g., FIG. 13), with the lowest threshold occurring at 1450 nm in this range. Wavelengths can also be between about 1400 nm (plus or minus about 10%) and about 1490 nm (plus or minus about 10%). FIG. 13 illustrates an exemplary graph showing excitation vs. emission intensity curves on an 8% Tm³⁺ doped nanoparticle film for different excitation wavelengths in the NIR-II spectral window according to an exemplary embodiment of the present disclosure.

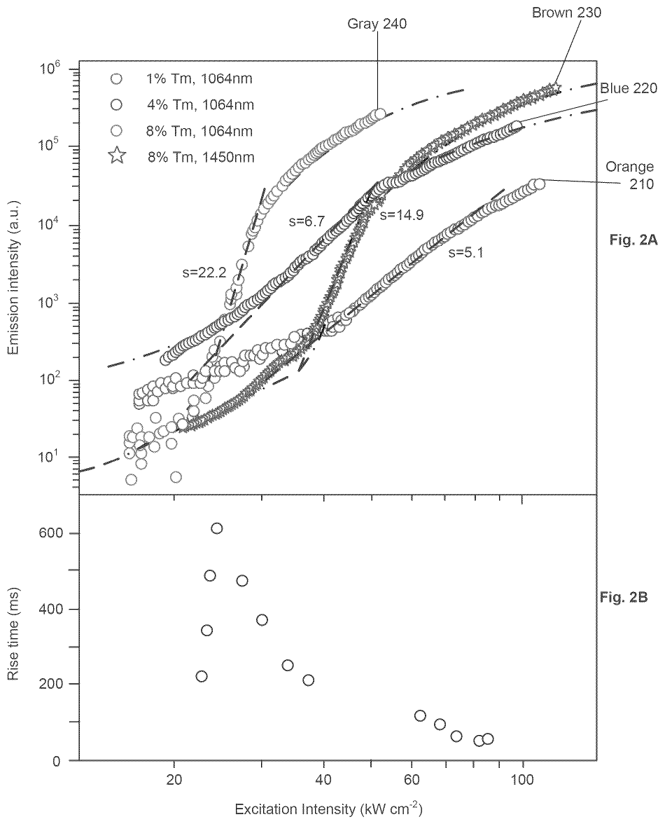

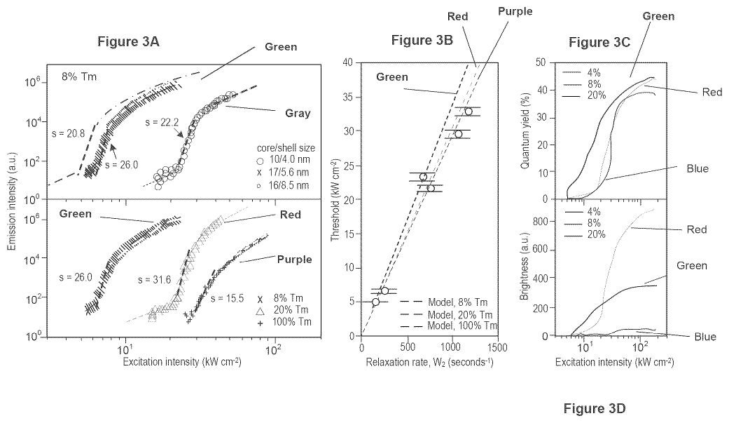

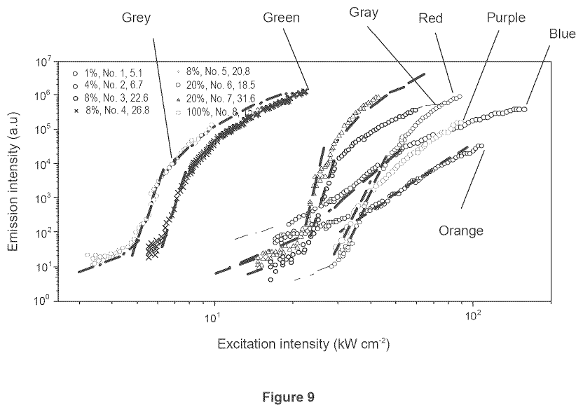

Recent theoretical treatments show that achieving PA with a large nonlinearity can involve a balance between several coexisting phenomena within the material. (See, e.g., Reference 7). But in the case where the cross-relaxation rate s₃₁>>W₂, the DRE model can predict that threshold intensity can be determined entirely by W₂. (See e.g., references 5 and 17). In ANPs, s₃₁ can be controlled by Ln³⁺ concentration, while the nonradiative decay component of W₂ can be dominated by losses at surfaces and interfaces. (See, e.g., References 29, 34, 35, 44, and 45). To determine if rebalancing these factors can reduce threshold intensity, two new 8% Tm³⁺ core/shell structures designed to reduce surface losses and thus W₂ were synthesized. These designs include thicker shells as well as larger core size than the 8% ANPs in FIG. 2, serving to further reduce the surface-to-volume ratio. The changes indeed result in a distinct reduction in threshold, to <10 kW cm⁻² at room temperature. (See e.g., FIGS. 3A and 9).

FIGS. 3A-3D show a set of exemplary graphs indicating a modification of PA kinetics via ANP shell thickness, surface-to-volume ratio, and Tm³⁺ content accordingly to an exemplary embodiment of the present disclosure. For example, the top panel of FIG. 3A illustrates an exemplary graph indicating 800 nm emission intensity vs. 1064 nm excitation intensity curves for different core sizes/shell thicknesses of 8% Tm³⁺-doped ANPs accordingly to an exemplary embodiment. The bottom panel of FIG. 3A shows an exemplary graph showing ANPs with different Tm³⁺ concentrations according to an exemplary embodiment of the present disclosure. Green×symbols refer to 8% Tm³⁺, same for the top panel. Red triangles refer to 20% Tm³⁺, (see sample 7 data shown; curve for sample 6 with 20% Tm³⁺ shown in FIGS. 7 and 9). Purple+symbols refer to 100% Tm³⁺. See SI Tables 1 and 2 for measured dimensions and their standard deviations. The dash-dotted lines are fits of the PA DRE model to the data. All measurements on ensemble films. FIG. 3B is an exemplary plot of threshold intensity vs. W₂ extracted from the data in (FIG. 3A), showing linear dependencies on W₂, with slopes that depend on s₃₁ according to an exemplary embodiment of the present disclosure. Error bars can be determined from the standard deviations of the curve fittings shown in FIG. 7. FIG. 3C shows an exemplary graph indicating exemplary calculations of upconverting quantum yield, and FIG. 3D illustrates an exemplary graph indicating brightness vs. excitation intensity for 4%, 8%, and 20% Tm³⁺, using values from model fits to the green circles and red squares in (see FIG. 3A), and the blue circles provided in FIG. 2A.

FIG. 7 illustrates an exemplary graph showing an exemplary determination of photon avalanche thresholds according to an exemplary embodiment of the present disclosure. The threshold value can reflect the change in slope of the emission intensity vs. excitation intensity curve (measurements on ensemble films). Dotted black lines are linear fits of the data points below and above threshold, where the intersection is considered the photon avalanche threshold. Percentage values are Tm³⁺ doping, and sample numbers are listed (see Table 1 for sample info). Threshold values are listed in Table 3.

FIG. 9 shows an exemplary graph providing an exemplary indication of 800 nm emission intensity vs. 1064 nm excitation intensity curves for different core sizes/shell thicknesses of 1-100% Tm³⁺-doped ANP ensembles. Tm³⁺ concentrations, sample numbers (see FIG. 5, Table 1), and slope values of the log-log curves are shown in FIG. 9 in the associated legend.

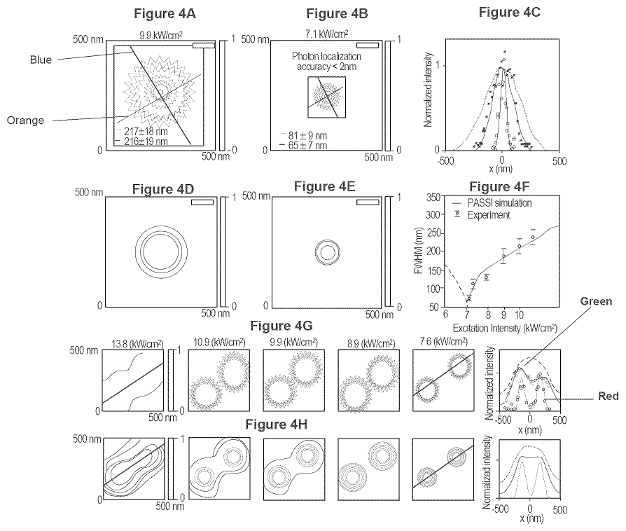

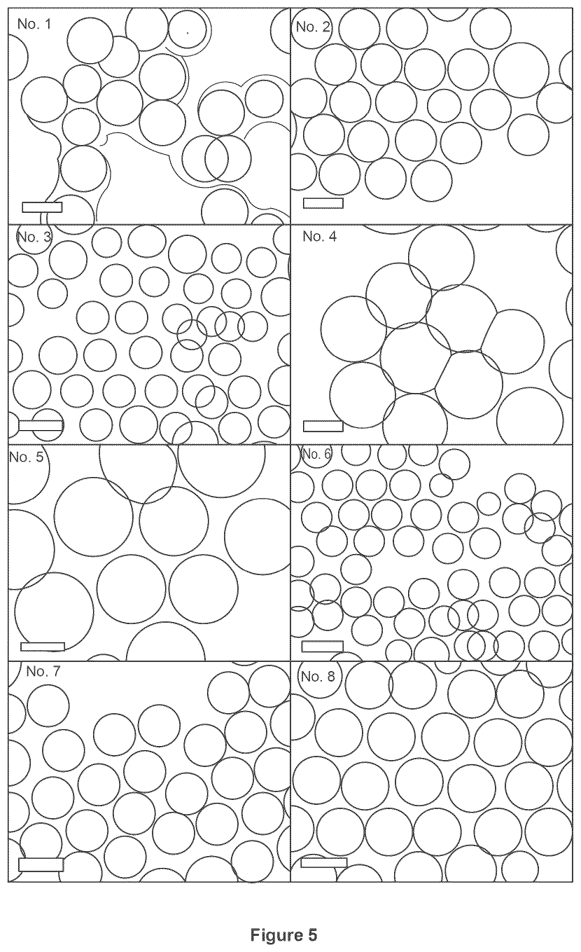

Increasing the Tm³⁺ content can change s₃₁ and W₂, and therefore the PA excitation threshold intensity. To study this effect, core/shell ANPs with 20% and 100% Tm³⁺ were synthesized (e.g., including two sizes of 20% Tm³⁺ ANPs; FIGS. 4A-4H), and threshold intensity can be found to increase with increasing Tm³⁺ content. (See e.g., FIG. 3A). This can be consistent with recent studies showing that, at these pump intensities, excited-state lifetimes can be reduced (e.g., W₂ can be increased) as Ln content increases within nanoparticles, with the resulting increase in ion-ion ET opening many potential relaxation pathways that act collectively to depopulate and repopulate the levels. (See, e.g., References 29 and 46).

Exemplary models can predict a linear dependence between PA threshold intensity and W₂, with a slope that can be determined by s₃₁, W₃ (e.g., the excited-state decay rate; see e.g., FIG. 1A), and the excited-state relaxation branching ratio. (See, e.g., Reference 5 and 17). These exemplary dependencies are shown in FIG. 3B for three different Tm³⁺ concentrations. As s₃₁ increases, W₃ and the branching ratio become less important, leading to a slight reduction in slope in the threshold intensity-W₂ curves. The presence of the 20% and 100% Tm³⁺ data points on nearly the same line can demonstrate that by the time Tm³⁺ content reaches 20%, s₃₁ can dominate, and the relative effects of W₃ and the branching ratio can become almost negligible. This well-defined relationship between the PA threshold and W₂ shown in FIG. 3B has important implications for sensing applications, where W₂ can be modulated by environmentally dependent ET to the ANP surface, with small changes in W₂ (e.g., and thus threshold) resulting in large changes in luminescence for a given pump intensity.

To evaluate the efficiency and relative brightness of ANPs, a kinetic computational model of ET within Ln³⁺-doped nanoparticles was used, similar to those used to reproduce the experimental upconverting quantum yields (“QYs”) of Er³⁺/Yb³⁺ co-doped UCNPs^{33,47}, as well as ELNPs (see, e.g., Reference 22) (“SI”). The exemplary calculations reveal that for fully passivated core-shell nanoparticles, QY can reach approximately 40% for ANPs excited beyond threshold at 10⁵ W cm⁻². (See e.g., FIG. 3C). While the model has known limitations—in particular, the absence of higher-energy excited states—calculated QYs can be consistent both with previous QY calculations for ELNPs (see, e.g., Reference 22) and QY measurements of PA-induced upconversion in fibers at room temperature. (See, e.g., Reference 16). In the exemplary calculations, it was found that while the 8% Tm³⁺ ANPs can be somewhat more efficient than 20% ANPs at this pump fluence, the 20% ANPs can be brighter. (See e.g., FIG. 3C). This can be because brightness can be a function of QY, but also the total number of emitters within the ANP (e.g., brightness can be defined as the product of the wavelength-dependent Tm³⁺ ion absorption cross-section, the Tm³⁺ concentration, and QY). The emission intensity shows a more nonlinear dependence on pump fluence than does QY, since the extreme nonlinearity of PA emission can be a function of both intensity-dependent QY and excited-state populations.

An application for ANPs can be single-particle superresolution imaging, as elucidated by the recently proposed photon-avalanche single-beam superresolution imaging (“PASSI”) concept that exploits the extreme nonlinear response of PA. (See, e.g., Reference 7). The size of the imaging point spread function in scanning confocal microscopy (“SCM”) scales inversely with the square root of the degree of nonlinearity s (e.g., as in multiphoton microscopy) (see, e.g., Reference 7), with the full width at half maximum (“FWHM”) of an imaged nonlinear emitter in SCM given by:

FWHM=λ/(2·NA·√s) (1)

in the Gaussian optics approximation (see, e.g., Reference 48) (e.g., where NA can be numerical aperture and λ can be wavelength). Therefore, deeply sub-wavelength resolution can be realized automatically with ANPs during standard SCM. The imaging may not need complex instrumentation, excitation beam shaping or patterning, image post-processing, or alignment procedures. (See, e.g., Reference 7).

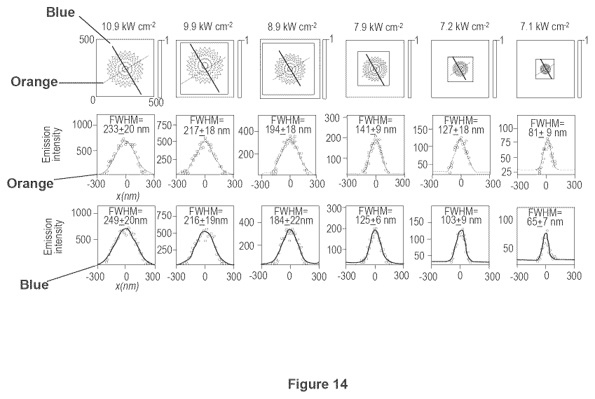

FIGS. 4A-4H illustrate exemplary images and graphs showing photon-avalanche single-beam superresolution imaging. In particular, FIGS. 4A and 4B show exemplary images of a single 8% Tm³⁺ ANP when excited in the saturation regime (9.9 kW cm⁻²) (see FIG. 3A), and in the PA regime (7.1 kW cm⁻²) (see FIG. 3B). FIG. 4C illustrates an exemplary graph provides exemplary linecuts corresponding to the blue lines in FIGS. 3A and 3B, along with a linecut through a theoretical diffraction-limited focused Gaussian spot (for example, for NA=1.49, λ=1064 nm). FIG. 4D provides an exemplary image showing simulations of PASSI images for the same excitation intensities in FIGS. 3A and 3B based on the measured emission vs. intensity curve shown in FIG. 3A (green×symbols). (See, e.g., Reference 7). FIG. 4F shows an exemplary graph showing measured (black) vs. simulated (red) FWHMs of single-ANP PASSI images as a function of excitation intensity. The exemplary PASSI simulations utilize values from the experimentally measured emission vs. intensity curve shown in FIG. 3A (green×symbols). Error bars are the root mean square of the standard deviations of Gaussian curve fittings of the two linecuts for each power in FIG. 14. FIG. 4G illustrates an exemplary image showing experimental PASSI images of 8% Tm³⁺ ANPs, separated by 300 nm, excited at decreasing intensities, from near saturation (left) to near threshold (right). Linecuts from the color-coded lines in the images, along with a linecut through a theoretical diffraction-limited image of linear emission from two emitters spaced by 300 nm (black dashed line) (far right). FIG. 4H shows an exemplary image providing substantially the same results as provided in FIG. 3G, except for PASSI simulations.

FIG. 14 illustrates a set of exemplary images and graphs showing 2D sub-diffraction resolution imaging of a single 8% Tm³⁺ core/shell ANPs accordingly to an exemplary embodiment of the present disclosure. Exemplary data points extracted along the linecuts are shown as circles the same color as linecuts. Data are fitted as Gaussian lineshapes. FWHM values and standard deviations of fitting are denoted in the plots. Narrowest FWHM is achieved with 7.1 kW cm⁻² excitation intensity (right panels) and threshold value is 6.4 kW cm⁻² (see Table 3)

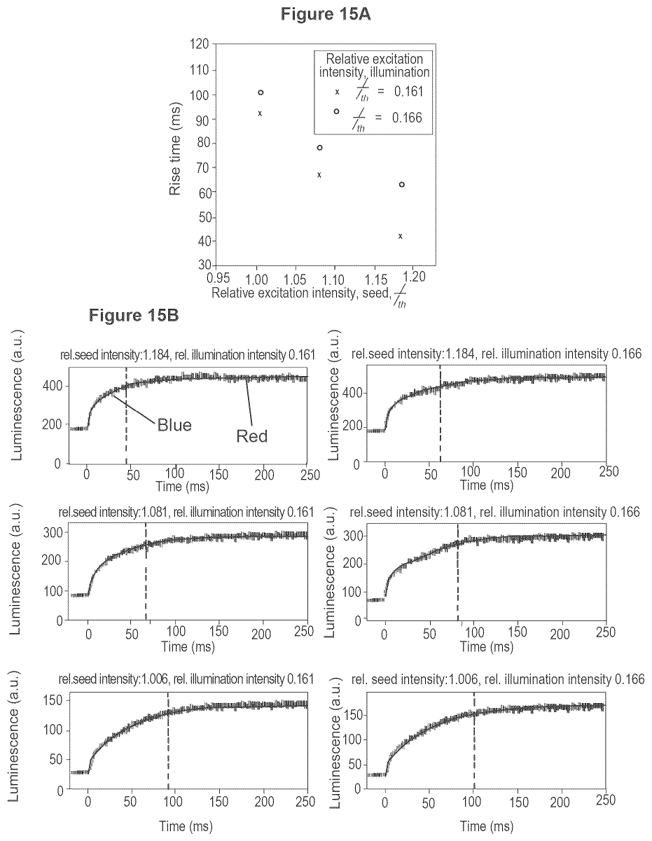

Exemplary single-ANP imaging, measuring a PASSI image spot of ≤75 nm average FWHM when excited at 1064 nm at the optimal pump intensity for PASSI was performed, which corresponds to emission intensity at the top of the steep segment of the response curve. (See, e.g., Reference 7). More specifically, the image of the 8% Tm³⁺ ANP, from the batch with s=26 (e.g., FIG. 3A), shows a short-axis FWHM of 65±7 nm and a long-axis FWHM of 81±9 nm (see, e.g., FIGS. 4B and 14), with its elliptical shape due to a slightly elliptical excitation spot. This spot size agrees well with PASSI simulations. (See e.g., FIG. 4E). The comparison with a diffraction limited excitation spot size of 357 nm FWHM clearly shows the advantage of the extreme nonlinearity of PA. (See e.g., FIG. 4A). As shown in FIG. 4A, the spot size can be approximately 220 nm FWHM when excited closer to the saturation regime, where the degree of nonlinearity s can be significantly lower, as predicted. (See, e.g., Reference 7). (See e.g., FIG. 4D). The theoretical resolution limit considering s=26 can be 70 nm, in excellent agreement with the measured values. PASSI superresolution and its unique power dependence can be readily apparent with two ANPs separated by 300 nm just resolvable when excited near saturation, but easily resolvable for intensities in the steep-slope region of the PA emission versus pump intensity curve. (See, e.g., FIGS. 4G and 4H). The resolution can be fully determined by the slope of the power-dependent emission (e.g., FIG. 4F) curve, facilitating the selection of the optimal intensity for imaging for a given ANP architecture once that curve can be measured. (See, e.g., Reference 7). Beyond PASSI, there can also be notable advantages for combining the steeply nonlinear ANPs with existing superresolution approaches. (See e.g., Table 11). For example, the extreme nonlinearity and anti-Stokes luminescence can improve the achievable signal-to-noise and resolution limits of methods such as nonlinear structured illumination microscopy (“SIM”) and near-infrared emission saturation (“NIRES”) (see, e.g., Reference 49) nanoscopy for a given photon budget. (See, e.g., References 9 and 10). Additionally, applying the photon localization accuracy concept to PASSI images (e.g., FIG. 4B), which already exhibit sub-100 nm resolution, yields a localization accuracy of <2 nm for only 7600 collected photons, compared to the 10-40 nm accuracies typically achieved. (See, e.g., Reference 8). Realizing that the longer rise times might limit scan rates (see, e.g., Reference 50), a multi-point excitation procedure (see, e.g., FIGS. 15A, 15B, 16A, 16B, and 17A-17C) was performed, which suggests possible scan rates of approximately 4 seconds or less per frame can be achievable and reasonable using multi-point PASSI.

FIGS. 15A and 15B provide exemplary graphs showing reduction of rise time with seed excitation according to an exemplary embodiment of the present disclosure. In particular, FIG. 15A illustrates an exemplary graph showing measured rise time vs. seed excitation intensity (intensities normalized to threshold intensity Iₜₕ). Seed excitation can be pre-irradiation onto the sample before the illumination excitation. Rise time can be measured with continuous seed excitation and oscillating illumination excitation (square wave). FIG. 15B shows a set of exemplary graphs showing time-resolved luminescence depending on seed and illumination excitation intensities. Red curves are bi-exponential fitting curves and black dashed lines indicate 90% rise time.

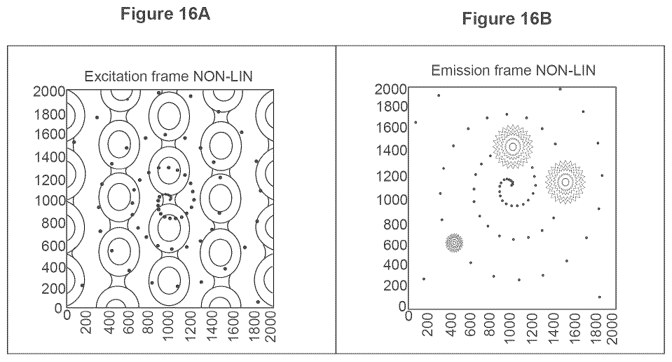

FIG. 16A shows an exemplary image of a hexagonal excitation pattern (orange) overlapped with an ANP phantom (spiral dots) according to an exemplary embodiment of the present disclosure. Efficient photoexcitation can obtained only for those ANPs that are very near the center of excitation patterns (green NPs). FIG. 16B illustrates an exemplary image showing only the excited ANPs contribute to luminescence image in a significant way according to an exemplary embodiment of present disclosure.

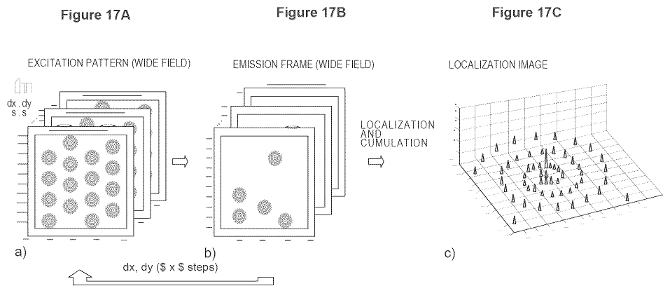

FIG. 17A shows an exemplary schematic presentation of parallel PASSI imaging using hexagonal multi-photoexcitation spots according to an exemplary embodiment of present disclosure. FIG. 17B illustrates an exemplary schematic presentation of parallel PASSI imaging using PA luminescence generation and ANP localization according to an exemplary embodiment of the present disclosure. The steps (A) and (B) in FIGS. 17A and 17B can be repeated for the hexagonal pattern being moved by pattern period divided by 5, to get 5×5=25 frames. By accumulation of localization of all these 25 frames, the ANP phantom is reconstructed with c.a. 80 nm optical resolution, which is displayed in FIG. 17C.

Additionally, in characterizing this PA system, an approximately 500-10,000-fold increases in emission intensity was measured when pump intensity can be increased from threshold (I_{P}^{th}) to twice the threshold value, which can be beyond the steep-slope region of the ANP response curve. (See e.g., FIGS. 2A and 3A). This enhancement, which can be defined as the parameter Δₐᵥ=I_{E}(2I_{P}^{th})/I_{E}(I_{P}^{th}), can be substantially larger than in reported energy-looping systems (e.g., Δₐᵥ≤50; references 11 and 22) and suggests a simpler empirical method of identifying PA using a single measurable ratio. Δₐᵥ captures the complex balance between R₂/R₁, cross-relaxation, and radiative vs non-radiative relaxation. (See, e.g., Reference 7). All nanoparticles with ≥8% Tm³⁺ content reported here can meet this criterion (e.g., Table 9, with a maximum value of approximately 10,000 attained with 20% Tm³⁺ ANPs, while a borderline value of approximately 500 can be seen in the 100% Tm³⁺ ANPs, where the large increase in cross-relaxation rates leads to faster nonradiative depopulation of ³H₄. (See, e.g., Reference 46).

Further, steeply nonlinear nanomaterials, realizing photon avalanching in engineered nanocrystals at room temperature with continuous wave pumping were observed. Core-shell architectures doped with only Tm³⁺ ions exhibit avalanching behavior for Tm³⁺ concentrations ≥8% were observed, and that the PA excitation threshold intensity can be fully determined by the ³F⁴ intermediate state lifetime at higher concentrations. Further, PA can be achieved for excitation in the 1400-1470 nm range in addition to 1064 nm. Along with emission intensities that scale nonlinearly with pump intensity up to the 26^{th} power—enabling sub-70 nm SCM imaging resolution and <2 nm photon localization—these results can open new applications in local environmental, optical, and chemical reporting, and in superresolution imaging.

### Exemplary Methods

### Exemplary Materials

Sodium trifluoroacetate (e.g., Na-TFA, 98%), sodium oleate, ammonium fluoride (“NH₄F”), Yttrium chloride (“YCl₃”, anhydrous, 99.99%), thulium chloride (“TmCl₃”, anhydrous, 99.9+%), Gadolinium chloride (“GdCl₃”, anhydrous, 99.99%), yttrium trifluoroacetate (e.g., 99.99+%), oleic acid (“Office Action”, 90%), and 1-octadecene (“ODE”, 90%) were purchased from Sigma-Aldrich.

### Exemplary Synthesis of Core ANPs

The synthesis of NaY₁₋ₓTmₓF₄ ANP cores, with average diameters ranging from d=10 to 18±1 nm (see e.g., Table 1) was based on reported procedures. (See, e.g., Reference 44). For the case of x=0.01 (e.g., meaning 1% Tm³⁺ doping), YCl₃ (e.g., 0.99 mmol, 193.3 mg) and TmCl₃ (e.g., 0.01 mmol, 2.8 mg) were added into a 50 ml 3-neck flask, followed by an addition of 6 ml OA and 14 ml ODE. The solution was stirred under vacuum and heated to 100° C. for 1 hour. During this time, the solution became clear. After that, the flask was subjected to three pump/purge cycles, each consisting of refilling with N₂ and immediately pumping under vacuum to remove water and oxygen. Thereafter, sodium oleate (e.g., 2.5 mmol, 762 mg) and NH₄F (e.g., 4 mmol, 148 mg) were added to the flask under N₂ flow. Subsequently, the resealed flask was placed under vacuum for 15 min at 100° C., followed by 3 pump/purge cycles. Subsequently, the flask was quickly heated from 100° C. to 320° C. (e.g., the approximate ramp rate was 25° C./min). The temperature was held at 320° C. for 40-60 min, after which the flask was rapidly cooled to room temperature with a stream of compressed air.

To isolate the nanoparticles, ethanol was added to the solution, and the precipitated nanoparticles were isolated by centrifugation (e.g., 5 min at 4000 rpm). The pellet was suspended in hexanes and centrifuged to remove large and aggregated particles. The nanoparticles remaining in the supernatant were washed two additional times by adding ethanol, isolating by centrifugation, and dissolving the pellet in hexanes. The nanoparticles were stored in hexanes with two drops of oleic acid to prevent aggregation.

### Exemplary Shell Growth

A 0.1 M stock solution of 20% GdCl₃ and 80% YCl₃ was prepared by adding YCl₃ (e.g., 2 mmol, 390.5 mg), GdCl₃ (e.g., 0.5 mmol, 131.8 mg), 10 ml OA and 15 ml ODE to a 50 ml 3-neck flask. The solution was stirred and heated to 110° C. under vacuum for 30 min. After that, the flask was filled with N₂ and heated to 200° C. for about 1 h, until the solution became clear and no solid was observed in the flask. Subsequently, the flask was cooled to 100° C. and placed under vacuum for 30 min. A 0.2 M solution of Na-TFA was prepared by stirring Na-TFA (e.g., 4 mmol, 544 mg), 10 ml OA and 10 ml ODE in a flask, under vacuum, at room temperature for 2 h, ensuring that all chemicals were dissolved. Using a nanoparticle synthesis robot, the

Workstation for Automated Nanocrystal Discovery and Analysis (“WANDA”), 3-9 nm NaY_{0.8}Gd_{0.2}F₄ shells (see Table 1) were grown on ANP cores using a layer-by-layer protocol. (See, e.g., Reference 3). Briefly, for a 3 nm shell thickness, 6 mL ODE and 4 mL OA were added to the dried ANP cores and heated to 280° C. at 20° C./min in the WANDA glove box. The automated protocol alternated between injections of a 0.2 M Na-TFA stock solution and a 0.1 M stock solution of 20% Gadolinium and 80% Yttrium oleate solution. One injection was performed every 20 minutes for a total of 12 injections (e.g., 6 injections for each precursor). Following the last injection, each reaction was annealed at 280° C. for an additional 30 minutes and then cooled rapidly by nitrogen flow. The particles were isolated and purified according to the purification protocol described for ANP cores. Core-shell NaYF₄ nanoparticles doped with Tm³⁺ (e.g., 1-100%) were synthesized using analogous methods.

### Exemplary Nanoparticle Characterization

TEM was performed using a JEOL JEM-2100F field emission transmission electron microscope (“TEM”) at an acceleration voltage of 200 kV, a FEI Themis 60-300 STEM/TEM operating at an acceleration voltage of 300 kV and a Tecnai T20 S-TWIN TEM operating at 200 kV with a LaB₆ filament. Size statistics were acquired for approximately 100 nanoparticles using ImageJ software. X-Ray diffraction (“XRD”) measurement was performed using a Bruker D8 Discover diffractometer with Cu Kα radiation. Average core diameter and shell sizes are given in FIG. 3A. The larger cores can be slightly prolate in shape. (See e.g., FIG. 6).

### Exemplary Preparation of Nanocrystal Film Samples

Nanoparticles (e.g., 40 μL of a 1 μM suspension in hexane) were either drop-cast or spincoated on a coverslip. AFM measurements (e.g., Bruker Dimension AFM) were performed to measure the thicknesses of the films.

### Exemplary Optical Characterization of ANPs

For single-ANP imaging, a dilute dispersion of nanoparticles was deposited on a glass coverslip and placed on an inverted confocal microscope (e.g., Nikon, Eclipse Ti-S inverted microscope). A 1064-nm continuous-wave diode laser (e.g., Thorlabs, FELH 750) or a Ti-sapphire pulsed laser (e.g., Coherent, Chameleon OPO Vis, 1390-1510 nm, 80 MHz) were directed into the back aperture of a 1.49 NA 100× immersion oil objective (e.g., Olympus), and focused directly to the sample on an 3D (e.g., XYZ) nanoscanning piezo stage (e.g., Physik Instrumente, P-545.xR8S Plano).

For measurements on film samples, a 0.95 NA 100× air objective lens (e.g., Nikon) was used. Emitted light was collected back through the same objective, filtered by 850-nm short-pass (e.g., Thorlabs, FESH 850) and 750-nm long-pass (e.g., Thorlabs, FELH 750) filters and sent to an EMCCD-equipped spectrometer (e.g., Princeton Instruments, ProEM: 1600² eXcelon™3) or a single-photon avalanche diode (e.g., Micro Photon Device, PDM series). For power dependence measurements, a neutral density wheel with a continuously variable density was used, synchronized with the collection system and automatically rotated by an Arduino-controlled rotator. Powers were simultaneously recorded by a Thorlabs power meter by using a glass coverslip to reflect approximately 10% of the incoming flux. Average excitation power densities were calculated using measured laser powers and using the 1/e² area calculated from the imaged laser spot.

### Exemplary Time-Resolved Photoluminescence

Samples were excited with a diode laser (e.g., Thorlabs) modulated at frequencies from 0.5 to 5 Hz by a function generator (e.g., Stanford Research Systems DS345). Emitted light collected by the 0.95 NA 100× objective (e.g., Nikon) was detected by a single photon avalanche diode (e.g., Micro Photon Device, PDM series). A time-correlated single-photon counting (“TCSPC”) device (Picoquant, Hydraharp 400) was used to record the timing data.

### PA Mechanism in ANPs

As discussed herein, a single ground-state absorption (“GSA”) event in lanthanide-based PA initiates a chain reaction of excited-state absorption (“ESA”) and cross-relaxation events between lanthanide (“Ln^{3+″}”) ions, resulting in the emission of many upconverted photons. This mechanism amplifies the population of excited states, such as the 800-nm-emitting Tm^{3+ 3}H₄ level (FIG. 1C), through a positive feedback loop of ESA from an intermediate state (“³F₄”) followed by cross-relaxation (e.g., an energy transfer process) back down to the same intermediate state while promoting a second ground-state Tm³⁺ ion up to its intermediate state (e.g., note that the cross-relaxation process can be accompanied by the emission of phonons to compensate an energy mismatch of ca. 1200 cm⁻¹). This process can effectively double the ³F₄ population on every iteration of the loop, and the repeated looping results in nonlinear amplification of excited state populations.

The ESA can be effective because the absorption peak for the electronic ³F₂-³F₄ transition can be close to the 1064 nm excitation wavelength. However, the 1064 nm photons can have an energy mismatch of approximately 1200 cm⁻¹ for the electronic ³H₆-³H₅ transition, which decreases the GSA cross section at that wavelength. Due to the energetic mismatch, GSA can be a phonon-assisted process in this case, which makes its oscillator strength very small, approximately 10⁴ times weaker than for excitation resonant with the purely electronic f-f transitions.

### Exemplary Materials for Achieving PA in Nanoparticles

PA was first observed at low temperatures—and this can often be the case—though there have now been a fair amount of room temperature demonstrations in bulk systems. (See e.g., references 5-7, 18, and 51-55). In nanomaterials, however, the sensitivity of Ln³⁺ photophysics to local material properties can preclude the realization of PA and can hinder room temperature operation.

As noted in the main text, four key innovations were combined to design nanocrystals that can be capable of PA. The first can be the recent design paradigm for Ln³⁺-based upconverting nanoparticles (“UCNPs”), in which high Ln³⁺ content, engineered energy confinement, and reduced surface losses result in exceptional efficiencies and brightness. (See, e.g., References 23, 29, 33-37, and 56). A second feature can be the choice of Tm³⁺ (e.g., FIG. 1A), an ion with a particularly slow intermediate-state decay rate W₂, which can influence PA behavior. (See, e.g., References 5-7). The third critical aspect exploits the compositional strategy employed previously for energy looping nanoparticles (“ELNPs”) (see, e.g., Reference 22), in which typical Yb³⁺ sensitizers can be omitted and high concentrations of Tm³⁺ ions can be doped into a β-phase NaYF₄ matrix, enhancing Tm³⁺-Tm³⁺ cross-relaxation and ESA while reducing GSA. (See e.g., FIG. 1). The fourth key element, also shared with ELNPs, can be the selection of excitation wavelengths in the NIR-II transparency window (e.g., either 1064 nm or 1450 nm; FIG. 1), which can be optimized for resonant ESA while maintaining non-resonant GSA, in contrast to the usual wavelengths used for pumping Tm3+ (e.g., 800 nm, or 980 nm when combined with Yb3+ sensitization; FIG. 1). (See, e.g., References 6, 11, 12, 21, and 38).

To determine if these design criteria enable nanocrystals to host PA, Tm³⁺-doped β-NaYF₄ core/shell structures 16-33 nm in total diameter were synthesized. (See, e.g., References 29 and 33). As described in synthesis and shell growth sections above, the Tm³⁺-doped core in each ANP can be surrounded by an optically inert shell to minimize surface losses (see, e.g., Reference 33). (See e.g., FIGS. 1, 5, and 6, and Tables 1 and 2). These nanoparticles can be excited in the NIR-II region to emit in the NIR-I region at 800 nm. (See, e.g., Reference 22). Both spectral windows can be valuable for imaging with limited photodamage through living systems or scattering media. (See, e.g., Reference 57). More generally, the NIR operation and exceptional photostability, along with an exemplary combination of steep nonlinearity and efficiency offered by PA, suggest their utility in a diverse array of applications including sub-wavelength bioimaging (see, e.g., References 7, 11, and 12), photonics and light detection (see, e.g., References 56-58), temperature (see, e.g., References 13, 14, and 59) and pressure (see, e.g., Reference 15) transduction, neuromorphic computing (see, e.g., Reference 60), and quantum optics. (See, e.g., References 61 and 62).

### Exemplary Differential Rate Equation Modeling of Photon Avalanching Behavior in ANPs

Differential Rate equation (“DRE”) modelling of the Tm³⁺ doped system was performed based on the 3-level system. (See, e.g., Reference 1). The integrated rate equations can be expressed as:

$$\frac{{dn}_{3}}{dt} = {σ}^{ESA} \frac{{I}_{p}}{h υ} {n}_{2} - ( {W}_{3}^{R} + {W}_{3}^{NR} ) {n}_{3} - {s}_{31} {n}_{3} {n}_{1} + {Q}_{23} {n}_{2}^{2} \qquad ( 2 )$$

$$\frac{{dn}_{2}}{dt} = {σ}^{GSA} \frac{{I}_{p}}{h υ} {n}_{1} - {σ}^{ESA} \frac{{I}_{p}}{h υ} {n}_{2} - ( {W}_{2}^{R} + {W}_{2}^{NR} ) {n}_{2} + ( {b}_{32} {W}_{3}^{R} + {W}_{3}^{NR} ) {n}_{3} + 2 {s}_{31} {n}_{3} {n}_{1} - ( {Q}_{22} + 2 {Q}_{23} ) {n}_{2}^{2} \qquad ( 3 )$$

$${n}_{1} + {n}_{2} + {n}_{3} = 1 \qquad ( 4 )$$

These equations may involve the ground-state and excited-state absorption coefficients σ^{GSA} and σ^{ESA}, radiative and non-radiative relaxation rates Wᵢ^{R} and Wᵢ^{NR} of level i (e.g., excluding cross-relaxation), the branching ratio b₃₂, (e.g., the sum of radiative relaxation rates from the ³H₄ level to intermediate levels divided by W₃^{R}), and the cross-relaxation rate s₃₁. In addition, to consider the inverse process of the s₃₁ cross relaxation, an inverse process of the cross relaxation (e.g., ³F₄+³F₄→³H₆+³H₄) and an upconversion process (e.g., ³F₄+³F₄→³H₆+³F₄) can be considered by the Q₂₂n₂² and Q₂₃n₂² terms, as in the model by S. Guy and F. Joubert.² The populations nᵢ of level i at steady state can be derived by solving the integrated rate equation with the Runge-Kutta 4^{th} order method.

The radiative relaxation rates can be calculated using crystal Judd-Ofelt parameters for β-NaGdF₄:Tm³⁺ which can have comparable lattice phonon energy³, and reduced matrix elements for Tm³⁺ ions (e.g., Table 5)⁴. The parameters that can be related to energy transfer between Tm³⁺ ions as a function of dopant concentration c can be expressed as, for example:

$${s}_{31} = {a}_{cr} {c}^{2} \qquad ( 5 )$$

$${Q}_{22} = {a}_{inv} \frac{{c}^{3}}{{c}^{2} + {4.3}^{2}} \qquad ( 6 )$$

$${Q}_{23} = {a}_{uc} \frac{{c}^{3}}{{c}^{2} + {4.3}^{2}} \qquad ( 7 )$$

whereas σ^{ESA},W₂^{NR},W₃^{NR},a_{cr},aᵢₙᵥ, and a_{uc} can be derived from the fitting of simulation results to experimental data as shown in Tables 4 and 5. The nonradiative relaxation. W₃^{NR} can be approximately twice as high as W₂^{NR}, which seems reasonable considering the fact that the energy gap between the ³F₄ and ³H₆ level (e.g., approximately 4300 cm⁻¹) can be somewhat smaller than that between the ³H₄ and ³H₅ levels (e.g., approximately 5700 cm⁻¹). This model assumed W₂^{NR} and W₃^{NR} can be negligible for sample No. 5 because multiphonon relaxation rates of Ln³⁺ ions in LaF₃ at the ³H₄ and ³F₄ levels can be calculated to be at least 4 order of magnitude smaller than other parameters,^{7,8} and the shell thickness of sample No. 5 can be over 6 nm, which was reported to be thick enough to prevent surface quenching.⁹

The result shows that the ratio of the ESA to GSA rates can be 10667, above 10000, a criterion for a clear avalanche threshold¹⁰. This high contrast of The ESA rate can be 1.83 times higher than that for Tm³⁺ doped silica fiber (e.g., Table 6). (See, e.g., Reference 11). That could be explained by, e.g., the phonon energy difference of the host lattices, along with linewidth narrowing. The coefficients of energy transfer between ions can be estimated at approximately 10% of those measure in YAG⁵. The decreases can also be attributed to the differences in phonon-assisted energy transfer depending on the host lattices, which has been shown by F. Auzel and F. Pelle¹². The narrowing of absorption linewidths decreases the overlap of donor emission spectrum and acceptor absorption spectrum which reduces cross-relaxation energy transfer.

### Exemplary Calculating Excited State Absorption Cross-Sections

Absorption cross sections (e.g., σ_{int,ESA}), integrated over the entire ESA peak, can be calculated from Judd-Ofelt theory using the methods described in a recent review¹³. The ESA cross section σ_{ESA}(v̅) at a given excitation wavenumber (v̅) can be calculated by assuming that the ESA absorption peak can have a Gaussian lineshape with variance w2 (w=FWHM/(2\sqrt{ln (2)}).

### Exemplary Calculation of Quantum Yield

Exemplary theoretical quantum yield (“QY”) for the ³H₄→³H₆ transition (e.g., 800 nm) can be calculated by using the results from the DRE simulation. The equation can be expressed as:

$$QY = \frac{\# photons emitted}{\# photons absorbed} = \frac{( 1 - {b}_{32} ) {W}_{3}^{R} {n}_{3}}{{σ}^{GSA} \frac{{I}_{p}}{h υ} {n}_{1} + {σ}^{ESA} \frac{{I}_{p}}{h υ} {n}_{2}} \qquad ( 8 )$$

(hv=pump photon energy)

Bulk materials other than NaYF4 have hosted photon avalanching, which suggests that there can be opportunities to develop an entire class of PA probes for imaging and sensing. This can be possible with both other dopants (e.g., Pr3+, Ho3+, Er3+ also possibly co-doped with Yb3+) and other crystalline host materials (e.g., (Li/K)(Y/Gd/Lu)F4, (La/Ce)(Cl/B)3, CdF2, Y2O3, YAG, YAlO3, LnVO4) or even heavy glasses (e.g., ZBLAN)15. Therefore, the demarcated for PA in nanoparticles (e.g., using PA preconditioning, lack of sensitizer, and surface passivation) can facilitate the design of a variety of PA wavelengths and their further biomedical and technological applications.

In general, the same factors that promote photon avalanche can encourage high nonlinearities, such as a high ESA/GSA ratio, high cross-relaxation and energy transfer rates relative to other relaxation pathways, as well as emission branching ratios. Notably, the phonon energy and density of states, and thus crystalline structure of the host also plays a role in the efficiency of the phonon-assisted GSA and CR. Reducing the phonon energy of a host can proportionally increase the number of phonons utilized to bridge energy gaps between excitation radiation and GSA transition energies, and, according to the Energy Gap Law, exponentially decrease GSA transition rates.

The exemplary system, method and computer-accessible medium, according to an exemplary embodiments of the present disclosure, can provide a method to design a library of lanthanide-doped photon avalanche nanoparticles. The CR rate s₃₁ and relaxation rate W₂ can be fine-tuned by varying the Ln³⁺ concentration and by surface passivation, respectively. For larger variations in composition, many material parameters can be interdependent, which can complicate predictions of the optimal materials for PA. Crystal structure can determine both site symmetry and phonon energies. Meanwhile changing dopant type results in different transition energies, cross-relaxation rates, and relaxation rates. Thus, in the future, high-throughput rate equation simulations that account for the above factors can be considered for rapidly screening the many combinations of material parameters for PA behavior.

### Exemplary PASSI Simulations of Raster Scanned Confocal Imaging

For the sake of simplicity, but without any limitations, a Gaussian beam was used in all simulations. The Gaussian spot's FWHM can be established with a diffraction limit equation for pump beam λ_{P}=1064 nm and microscope objective NA=1.49 (e.g., to match experimental parameters). The definition of the beam was described by the equation S7.

$${I}_{G} ( x , y , {x}_{o} , {y}_{o} , {I}_{0} , λ ) = {I}_{0} \cdot exp ( - \frac{{( x - {x}_{o} )}^{2} + {( y - {y}_{o} )}^{2}}{{ω}^{2}} ) , \qquad ( 9 )$$

$$where ω = \frac{λ}{2 \cdot NA}$$

This I_{G} beam was scanned, by changing the position of the center (x₀, y₀) over either a single or a collection of 19.5×16 nm large homogenous ANPs, defined by a binary image TabNP(x,y) (0=no particle, 1=particle). The size of TabNP image defined the size of ultimate image, where each pixel corresponded to 1 nm in 2D space. The I₀ was determined from the experimental “S” curves from FIG. 3.

By multiplying the I_{G} by TabNP, a new table can be created that represents the excitation intensity at the location of the NP.

I_{P}(x₀, y₀)=TabNP(x, y)·I_{G}(x, y, x₀, y₀, I₀, 1064) (10)

The experimental “S” shaped dependence between pump and emission intensities was used in the simulations ((I_{EMI}=fun(I_{P})), and emission intensity at the position of the Gaussian excitation beam (x₀, y₀) was calculated (e.g., FIG. 4) by summing the contribution of every non-zero pixel from such emission image at this (x₀, y₀) position

I_{L}(x₀, y₀)=Σₓ_{₀}Σ_{y}_{₀}I_{EMI}(I_{P}(x₀, y₀)) (11)

### Exemplary Multi-Point Excitation PASSI Parallel Imaging

The simulations of multi-point excitation PASSI parallel imaging were performed in a very similar way, with some modifications to emulate detection combined with photon localization analysis. Briefly, a hexagonal pattern of Gaussian beams was generated. (See e.g., FIG. 13). Independently, a phantom sample was designed as previously by using 2000×2000 binary empty image, with ‘1’ indicating the position of an ANP. A spiral pattern of ANPs (see e.g., FIG. 13) was created, because this nicely shows the behavior of PASSI imaging versus distance between the ANPs under diffraction-limited optical resolution conditions. As previously, both the excitation pattern and phantom table were multiplied, which generated a new image, in which the pixel intensities indicated pump intensity.

At this point, these data were treated in a different way as compared to raster scanned imaging. Use of a 2D photodetector (e.g., a 2D pixel array) was assumed. Thus, every nanoparticle, excited with local pump intensity IP, became a source of a new diffraction limited Gaussian spot, whose luminescence intensity I_{P}, was determined by the experimental “S” shaped power dependence, and FWHM was calculated for emission wavelength (e.g., λ=800 nm). These diffraction limited spots were cumulated on a virtual CCD imager. Due to the very steep power dependence of ANPs, the hexagonal beam excitation pattern stimulated reasonable avalanche luminescence only from those ANPs that were matching exact centers of excitation beams (e.g., green spots in FIG. 13A).

By then adopting the photon localization method and searching for local maxima, the positions of individual ANPs can be determined accurately. By shifting the hexagonal pattern (e.g., FIG. 14A) in X and Y directions by a pattern period divided by 5, 5×5=25 luminescence images were acquired (e.g., FIG. 14B) and treated with the above-mentioned localization method. The localized ANP information was cumulated from all the 25 emission frames using amplitudes of emission (e.g., FIG. 14C). The simulated image of multiple ANPs using a hexagonal multi-point excitation pattern confirms the capability of ANPs to be distinguished at particle separation distances around 80 nm.

### Exemplary Comparisons of (i) ANPs with Nonlinear Responses in Other Ln-Based Nanomaterials and (ii) PASSI with Other Superresolution Methods

Photon avalanching materials were originally developed within the context of realizing new (e.g., efficient) lasers, and a number of successful demonstrations exist in literature. These bulk-material based PA results have been reviewed elsewhere. (See, e.g., References 1 and 2). As one can note, there can be many claims for PA (e.g., as slopes can be higher than 4 and simple ESA/ETU may not be enough to explain the UC process), but many can be unjustified as PA occurs when a few conditions can be satisfied simultaneously, for example, quasi linear power dependence below threshold AND saturation of luminescence at high pumping power and very high slopes (e.g., >10) above threshold AND power dependent slow rise times.

FIG. 18 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement) 1805. Such processing/computing arrangement 1805 can be, for example entirely or a part of, or include, but not limited to, a computer/processor 1810 that can include, for example one or more microprocessors, and use instructions stored on a computer-accessible medium (e.g., RAM, ROM, hard drive, or other storage device).

As shown in FIG. 18, for example a computer-accessible medium 1815 (e.g., as described herein above, a storage device such as a hard disk, floppy disk, memory stick, CD-ROM, RAM, ROM, etc., or a collection thereof) can be provided (e.g., in communication with the processing arrangement 1805). The computer-accessible medium 1815 can contain executable instructions 1820 thereon. In addition or alternatively, a storage arrangement 1825 can be provided separately from the computer-accessible medium 1815, which can provide the instructions to the processing arrangement 1805 so as to configure the processing arrangement to execute certain exemplary procedures, processes, and methods, as described herein above, for example.

Further, the exemplary processing arrangement 1805 can be provided with or include an input/output ports 1835, which can include, for example a wired network, a wireless network, the interne, an intranet, a data collection probe, a sensor, etc. As shown in FIG. 18, the exemplary processing arrangement 1805 can be in communication with an exemplary display arrangement 1830, which, according to certain exemplary embodiments of the present disclosure, can be a touch-screen configured for inputting information to the processing arrangement in addition to outputting information from the processing arrangement, for example. Further, the exemplary display arrangement 1830 and/or a storage arrangement 1825 can be used to display and/or store data in a user-accessible format and/or user-readable format.

The foregoing merely illustrates the principles of the disclosure. Various modifications and alterations to the described embodiments can be apparent to those skilled in the art in view of the teachings herein. It can thus be appreciated that those skilled in the art can be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as can be understood by those having ordinary skill in the art. In addition, certain terms used in the present disclosure, including the specification, drawings and claims thereof, can be used synonymously in certain instances, including, but not limited to, for example, data and information. It can be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it can be explicitly incorporated herein in its entirety. All publications referenced can be incorporated herein by reference in their entireties.

### Exemplary Tables

TABLE 1
The average core diameters and shell thicknesses of NaYF₄:
1-100% Tm³⁺@ NaY_{0.8}Gd_{0.2}F₄ core-shell nanocrystals

| Sample No. | Tm concentration | Core diameter | Shell thickness |
|---|---|---|---|
| 1 | 1% | 15.8 ± 1.5 nm | 3.0 ± 1.2 nm |
| 2 | 4% | 14.1 ± 1.5 nm | 3.8 ± 1.0 nm |
| 3 | 8% | 10.2 ± 1.1 nm | 4.0 ± 0.8 nm |
| 4 | 8% | 17.3 ± 0.8 nm | 5.6 ± 0.9 nm |
| 5 | 8% | 15.9 ± 1.0 nm | 8.5 ± 1.9 nm |
| 6 | 20% | 10.4 ± 1.0 nm | 2.7 ± 0.9 nm |
| 7 | 20% | 17.4 ± 0.8 nm | 2.6 ± 0.6 nm |
| 8 | 100% | 15.8 ± 1.3 nm | 4.2 ± 1.0 nm |

TABLE 2
The core sizes of nanoparticle samples with elliptical shapes

| Sample | Tm | Core diameter | | |
|---|---|---|---|---|
| No. | concentration | Major axis | Minor axis | Average |
| 1 | 1% | 17.3 ± 1.1 nm | 14.3 ± 1.3 nm | 15.8 ± 1.5 nm |
| 4 | 8% | 19.8 ± 0.8 nm | 15.1 ± 1.0 nm | 17.3 ± 0.8 nm |
| 5 | 8% | 17.5 ± 1.4 nm | 14.1 ± 1.3 nm | 15.9 ± 1.0 nm |
| 7 | 20% | 19.5 ± 1.0 nm | 15.5 ± 0.8 nm | 17.4 ± 0.8 nm |

TABLE 3
Photon avalanche threshold.

| Sample No. | Tm³⁺ concentration (%) | Threshold (kW cm⁻²) |
|---|---|---|
| 3 | 8 | 23.3 |
| 4 | 8 | 6.4 |
| 5 | 8 | 4.9 |
| 6 | 20 | 32.8 |
| 7 | 20 | 21.7 |
| 8 | 100 | 29.6 |

TABLE 4
Judd-Ofelt and relaxation parameters

| Parameter | Value |
|---|---|
| Ω₂ (10⁻²⁰ cm²) | 2.37 |
| Ω₄ | 3.05 |
| Ω₆ | 0.41 |
| W₂^{R} (s⁻¹) | 162.60 |
| W₃^{R} (s⁻¹) | 636.01 |
| b₃₂ | 0.144 |

TABLE 5
Reduced matrix elements for Tm³⁺(ref. 4).

| Electronic Transition | [U⁽²⁾]² | [U⁽⁴⁾]² | [U⁽⁶⁾]² |
|---|---|---|---|
| ³H₆ → ³F₄ | 0.5395 | 0.7261 | 0.2421 |
| → ³H₅ | 0.1074 | 0.2314 | 0.6385 |
| → ³H₄ | 0.2357 | 0.1081 | 0.5916 |
| ³F₄ → ³H₅ | 0.0909 | 0.1299 | 0.9264 |
| → ³H₄ | 0.1275 | 0.1311 | 0.2113 |
| ³H₅→ ³H₄ | 0.0131 | 0.4762 | 0.0095 |

TABLE 6
Derived absorption coefficients and coefficients for energy
transfer between ions from curve-fitting

| Parameter | Value | |
|---|---|---|
| σ^{GSA} (×10⁻²⁵ m²) | 6.0 × 10⁻⁴ | |
| σ^{ESA} (×10⁻²⁵ m²) | 6.4 | |
| a_{cr} (s⁻¹) | 160 | c > 4% |
| | 49.7 | c = 4% |
| aᵢₙᵥ (s⁻¹) | 25.6 | c > 4% |
| | 6.67 | c = 4% |
| a_{uc} (s⁻¹) | 9.00 | c > 4% |
| | 2.35 | c = 4% |

TABLE 7
Derived phonon-assisted non-radiative relaxation rates
from curve-fitting

| | Sample No. | | | | | | |
|---|---|---|---|---|---|---|---|
| Parameter | 2 | 3 | 4 | 5 | 6 | 7 | 8 |
| W₂^{NR} (s⁻¹) | 56.9 | 512 | 40.7 | ~0 | 976 | 585 | 862 |
| W₃^{NR} (s⁻¹) | 103.58 | 1030 | 87.3 | ~0 | 1957 | 1176 | 1730 |

TABLE 8
Phonon energy of host lattice and absorption cross section
at 1064 nm

| | Phonon | Absorption cross section |
|---|---|---|
| | energy | at 1064 nm, σ^{ESA} |
| Host lattice | (cm⁻¹) | (×10⁻²⁵ m²) |
| β-NaYF₄ | ~360 | 6.4 (DRE model fit to data) |
| Silica fiber | ~1050 | 3.5 (from experiment¹⁴) |

TABLE 9
Increase in emission Δₐᵥ when pump intensity can be increased
from the avalanche threshold pump intensity I_{P}^{th}
to twice the threshold pump intensity 2I_{P}^{th}.

| | | | Δₐᵥ = |
|---|---|---|---|
| | | | I_{E}(2I_{P}^{th})/I_{E}(I_{P}^{th}), |
| | Sample | Nanoparticle | experiment (800 |
| | No. | composition | nm emission) |
| FIG. 2A | 1 | 1% Tm (1064 nm) | 26 |
| | 2 | 4% Tm (1064 nm) | 34 |
| | 3 | 8% Tm (1064 nm) | 2029 |
| | 3 | 8% Tm (1450 nm) | 1025 |
| FIG. 3A | 3 | 8%, core/shell = 10/4.0 nm | 2029 |
| upper | 4 | 8%, core/shell = 17/5.6 nm | 1347 |
| panel | 5 | 8%, core/shell = 16/8.5 nm | 1190 |
| FIG. 3A | 3 | 8% Tm | 1347 |
| bottom | 7 | 20% Tm | 9691 |
| panel | 8 | 100% Tm | 491 |
| An | 6 | 20% Tm | 6142 |
| additional | | | |
| sample | | | |

TABLE 10
Exemplary Comparison of representative examples of energy-looping
luminescence in Ln doped nanomaterials. I_{TH}, I_{SAT}, S_{MAX}, RT and τ₉₀ respectively can denote
excitation power threshold and saturation (if any provided), highest power dependence slope,
presence of the clear PA features—power dependent risetimes (τ_{R}) with the time required to get
c.a. 90% of steady state emission (τ₉₀); Legend: the [symbol] symbols denote missing/unavailable
information, [symbol] denote the feature was observed but (possibly) no numerical values were
provided/possible to extract; NC—nanocrystals; C@S denote core-shell NPs, where size or
composition can differ between core and shell; T_{O}—operating temperature; RT—room
temperature operation. The I_{TH} and I_{SAT} can be in [kW cm⁻²], unless these numbers were
provided in power units only.

| | | λ_{EXC}/λ_{EMT} | I_{TH}/I_{SAT} | S_{MAX}/τ_{R}/τ₉₀ | T_{O} | | |
|---|---|---|---|---|---|---|---|
| Ln³⁺ | Host:dopant:size | [nm/nm] | [kW cm⁻²] | [n.a./n.a./s] | [° C.] | Additional comments | Refs. |
| Nd | 1% Nd/5% Yb YAG NC | 976/597 | 400 mW/ [symbol] | 5.4/ [symbol] /2 | RT | Hot emission proposed | 16 |
| | ceramics | | | | | | |
| | Size: [symbol] | | | | | | |
| Ce | CeVO₄ | 808/450-670 | [symbol] / [symbol] | 7.8 (straw- | [symbol] | Larger microscale aggregates of | 17 |
| | (nanoplates, nanowires, | | | sheaves)/ | | nanoparticles; PA when strong | |
| | straw-sheaves) | | | [symbol] / [symbol] | | cross-relaxation present in | |
| | Size: 10 × 50 nm | | | | | aggregates. | |
| Nd | NdVO₄, (nanoplates, | 808/500-650 | [symbol] / [symbol] | 14.1 (straw- | [symbol] | Larger microscale aggregates of | 17 |
| | nanowires, straw-sheaves) | | | sheaves)/ [symbol] / [symbol] | | nanoparticles; PA when strong | |
| | Size: 10 × 50 nm | | | | | cross-relaxation present in | |
| | | | | | | aggregates. | |
| Ce | CeVO₄, square plates size: 30 | 800/593 | 23 mW/ [symbol] | 15/ [symbol] / [symbol] | [symbol] | Larger microscale aggregates of | 18 |
| | nm-40 nm | | | | | nanoparticles; PA when strong | |
| | | | | | | cross-relaxation present in | |
| | | | | | | aggregates. | |
| Nd | NdVO₄ | 800 nm/584 | 8 mW/ [symbol] | 22/ [symbol] / [symbol] | [symbol] | Larger microscale aggregates of | 18 |
| | 30 nm wide, 6-8 nm longnm | nm | | | | nanoparticles; PA when strong | |
| | (like H letter) | | | | | cross-relaxation present in | |
| | | | | | | aggregates. | |
| Nd | Nd_{0.1}Y_{0.9}VO₄ | 808/593, 535 | 90 mW/ | 9.5 (@593 nm)/ [symbol] / | [symbol] | | 19 |
| | NdVO₄ | | [symbol] @593 nm | [symbol] | | | |
| | Size: 30 × 9 nm | | 60 mW/ | 6.7 (@535 nm)/ | | | |
| | | | [symbol] @535 nm | [symbol] /50 ns | | | |
| Pr | Glass, glass ceramics, | 976/Vis | 1.7 mW/2.2 | 5.28 (@548 nm)/ | [symbol] | | 20 |
| | ceramics nanocrystals | | mW | [symbol] / [symbol] | | | |
| | size: 25-50 nm (calculated | | | | | | |
| | from XRD) | | | | | | |
| Tm | NaYF₄:x%Tm20% Gd(x = 0.1 | 1064/800 | ~1.6 mW/ | 3.2/ [symbol] / [symbol] | [symbol] | | 21 |
| | to 1.5) | | ~2.0 mW | | | | |
| | Size: 40 nm | | | | | | |
| Ho | Ho³⁺-Yb³⁺ co-doped glass- | 745/545, | 0.410/ [symbol] | 3.1/ [symbol] /0.013 | RT | | 22 |
| | ceramics containing CaF₂ | 650 | | | | | |
| | nanocrystals | | | | | | |
| | Size: 8, 10, 13, 18 nm | | | | | | |
| Er | 5% ErYb P₄O₁₂ | 980/548, | 1W/ [symbol] | 1.5-3.5 (@545); | [symbol] | | 23 |
| | 5% ErYbP₅O₁₄ | 650 | 0.6W/ [symbol] | 1-4 (@654)/ [symbol] / | | | |
| | Size: 26-30 nm | | | [symbol] | | | |
| Ho | 1Ho:Lu₃Ga₅O₁₂ | 751/545 | 0.331/ [symbol] | 2.54/ [symbol] / [symbol] | [symbol] | | 24 |
| | 1Ho:Y₃Ga₅O₁₂ | | 0.238/ [symbol] | 2.14/ [symbol] / [symbol] | | | |
| | Size: 50-90 nm | | | | | | |
| Tm | NaYF₄:20% Gd³⁺, 0.1-1.5 | 1064/800 | 0.4/0.5 | 3.2/ [symbol] / [symbol] | [symbol] | | |
| | %Tm³⁺ | | | | | | 25 |
| | Size: 10 nm | | | | | | |
| Ho | Ho_{0.5}:Gd₂O₃ | 976/ | 150/350 mW | 4.8 @553, 4.5@669/ | [symbol] | | |
| | Ho_{0.5}:Yb₃:Gd₂O₃ | 553, 669 | | [symbol] /0.005@553 nm | | | 26 |
| | Annealed Ho_{0.5}:Yb₃:Gd₂O₃ | | | | | | |
| | Size: ~100 nm | | | | | | |
| Tm | Yb/Tm co-doped NaYF₄ | 980, | [symbol] / [symbol] | 3.13/ [symbol] / [symbol] | RT | | 27 |
| | UCNPs | 980 + 808/455 | | | | | |
| | 20% Yb 0.5%-8% Tm | | | | | | |
| | Size: 40n m | | | | | | |
| Er | Gd₂O₃₋ₓSₓ:Er | 978/671, 549 0 | [symbol] / [symbol] | [symbol] / [symbol] / [symbol] | [symbol] | | 28 |
| | Size: 7, 47 and 49 nm | | | | | | |
| Nd | Nd³⁺ doped NPs: NaYF₄, | 1064/800 | 0.7 W at 10° C. in | [symbol] / [symbol] / [symbol] | 10-200° C. | anti-Stokes avalanche-like NIR | 29 |
| | Y₂O₃, YGdO₃, YAlO₃, | | LiLaP₄O₁₂:Nd³⁺ | | | emission | |
| | Y₃Al₅O₁₂, LiLaP₄O₁₂, Gd₂O₃ | | | | | | |
| | Size: 10-20 nm | | | | | | |
| Nd | in silico modelling of the PA | 1064/800 | [symbol] / [symbol] | 10 (up to 80)/ [symbol] / | RT | in silico modelling of the | 30 |
| | in Nd³⁺:NPs | | | [symbol] | | photon avalanche phenomenon | |
| | | | | | | for photon avalanche assisted | |
| | | | | | | single beam super-resolution | |
| | | | | | | imaging (PASSI) | |
| Er | BiOCl:Er³⁺ | 980/ | 0.085/ [symbol] | 7.86 (red)/ | [symbol] | | 31 |
| | Nanosheets | 540, 650 | | [symbol] / [symbol] | | | |
| | Size: 150, 70, 35 nm | | | | | | |
| Tm | NaYF₄: 20% Yb, 8% Tm | 976/455 | 100/250 | 6.2/ [symbol] / [symbol] | [symbol] | super-linear emitters, 3D sub- | 32 |
| | Size: 46 nm | | | | | diffraction imaging | |
| Tm | NaYF₄: 20% Yb, 8% Tm | 976 (exc) + 808 | N/A/550 | 6.4/ [symbol] / [symbol] | [symbol] | Simultaneous super-linear | 33 |
| | Size: 46 nm | (dep)/455 | | | | excitation-emission and | |
| | | | | | | emission depletion | |
| Tm | NaYF₄: 20% Yb³⁺, x% Tm³⁺ | 976/800 | 1-1000/ | [symbol] / [symbol] / [symbol] | [symbol] | Upconversion Nonlinear | 34 |
| | NPs, x = 0.5-8 | | 100-10000 | | | Structured Illumination | |
| | NaYF₄: x% Yb³⁺, 4% Tm³⁺ | | | | | Microscopy | |
| | NPs, x = 20-80 | | | | | | |
| | Size: ~20 nm | | | | | | |
| Tm | [β-NaYF₄ @ β-NaYF₄ | 1064/800; | 6/8 | Photon | RT | I_{TH}, S_{MAX} varied with dopant | This |
| | >8% Tm @ . . . | 1450/800 | 35/45 | avalanching | RT | concentration, shell thickness | work |
| | Size: 17@5.6 nm | | | 26/ [symbol] /0.6 | | and λ_{EXC}; First demo of super- | |
| | | | | 14.3/ [symbol] / [symbol] | | resolution imaging with PASSI | |

TABLE 11
Overview of superresolution microscopy techniques including PASSI.
$: low cost, $$: Moderate cost, $$$: High cost, ✓: yes/possible, SR-SIM: super-resolution structured illumination microscopy,

| | | | | | | | | | | | Noadditional | |
|---|---|---|---|---|---|---|---|---|---|---|---|---|
| | | | | | | | | | | | computation/ | |
| | | | | 2-color/ | | | | | | Localization | post- | |
| | | Principle: | 3D res:/ | multi- | Live | Ease of | | Sample | Thick | or resolution | processing | |
| Method | | detector | stack | color | cell | use | Costs | prep. | >20 μm | Improvement | requirements | Refs. |
| SR- | Re-scan | Single- | —/√ | √/√ | √ | Easy | $ | Easy | √ | Low | — | 36 |
| SIM | | point | | | | | | | | | | |
| | | scanning: | | | | | | | | | | |
| | | camera | | | | | | | | | | |
| | Airyscan | Single- | √/√ | √/√ | √ | Easy | $$ | Easy | √ | Low | — | 37-39 |
| | | point | | | | | | | | | | |
| | | scanning: | | | | | | | | | | |
| | | Photo- | | | | | | | | | | |
| | | detector | | | | | | | | | | |
| | | array | | | | | | | | | | |
| | iSIM | Multi- | √/√ | √/√ | √ | Easy | $$ | Easy | √ | Low | — | 39, 40 |
| | | point | | | | | | | | | | |
| | | scanning: | | | | | | | | | | |
| | | camera | | | | | | | | | | |
| | Interference- | Wide-field | √/√ | √/√ | √ | Moderate | $$$ | Moderate | — | Moderate | — | 41-44 |
| | based 2D/3D | (TIRF); | | | | | | | | | | |
| | SIM | camera | | | | | | | | | | |
| STED | | Point | √/√ | √/— | —/√ | Moderate | $$$/$ | Easy | √ | High | √ | 45 |
| | | scanning: | | | | | | | | | | |
| | | Photo- | | | | | | | | | | |
| | | detector | | | | | | | | | | |
| RESOLFT | | STED, SIM | √/— | —/— | √ | Moderate | $$$ | Difficult | — | High | √ | 44, 46, 47 |
| SM/LM | | Wide-field, | √/— | √/— | — | Moderate | $$ | Difficult | — | High | — | 48, 49 |
| | | TIRF, HILO; | | | | | | | | | | |
| | | camera | | | | | | | | | | |
| SOFI/SRRF | | Algorithm | √ | √/— | √ | Moderate | $ | Moderate | — | Moderate | — | 50, 51 |
| LLS | | Light- | √ | √/— | √ | Difficult | $$$ | Moderate | √ | Low | √ | 52 |
| | | sheet and | | | | | | | | | | |
| | | SIM; | | | | | | | | | | |
| | | camera | | | | | | | | | | |
| ExM | | Sample | √ | √/√ | — | Easy | $-$$ | Moderate | √ | High | √ | 53-55 |
| | | prep. kit | | | | | | | | | | |

| | | | | | | | | | | | |
|---|---|---|---|---|---|---|---|---|---|---|---|
| PASSI/uSEE | Point | √/√ | —/— | √(?) | Easy | $ | Easy | √ | High | √ | 30, 32, |
| | scanning: | | | | | | | | | | This |
| | Photo- | | | | | | | | | | work |
| | detector/ | | | | | | | | | | |
| | Multi- | | | | | | | | | | |
| | point | | | | | | | | | | |
| | scanning; | | | | | | | | | | |
| | camera | | | | | | | | | | |

iSIM: instant structured illumination microscopy,
STED: stimulated emission depletion microscopy,
RESOLFT: reversible, saturable optical linear fluorescence transitions,
SMLM: single-molecule localization microscopy,
SOFI: super-resolution optical fluctuation imaging,
SRRF: super-resolution ring correlation,
LLS: lattice light sheet,
ExM: expansion microscopy,
PASSI: photon avalanche single beam super-resolution imaging,
uSEE: super-linear excitation-emission.

### EXEMPLARY REFERENCES

The following references are hereby incorporated by reference, in their entireties:
1. Turcotte, D. L. Self-organized criticality. Rep. Prog. Phys. 62, 1377-1429 (1999).
2. Ni, H. & Rand, S. C. Avalanche phase conjugation. Opt. Lett. 17, 1222-1224 (1992).
3. Chivian, J. S., Case, W. E. & Eden, D. D. The photon avalanche: A new phenomenon in Pr3+-based infrared quantum counters. Appl. Phys. Lett. 35, 124-125 (1979).
4. Lenth, W. & Macfarlane, R. M. Excitation mechanisms for upconversion lasers. J. Lumin. 45, 346-350 (1990).
5. Joubert, M.-F. Photon avalanche upconversion in rare earth laser materials. Optical Materials 11, 181-203 (1999).
6. Auzel, F. Upconversion and Anti-Stokes Processes with f and d Ions in Solids. Chemical Reviews 104, 139-174 (2004).
7. Bednarkiewicz, A., Chan, E. M., Kotulska, A., Marciniak, L. & Prorok, K. Photon avalanche in lanthanide doped nanoparticles for biomedical applications: super-resolution imaging. Nanoscale Horizons 4, 881-889 (2019).
8. Thompson, M. A., Lew, M. D. & Moerner, W. E. Extending Microscopic Resolution with Single-Molecule Imaging and Active Control. Annual Review of Biophysics 41, 321-342 (2012).
9. Gustafsson, M. G. L. Nonlinear structured-illumination microscopy: Wide-field fluorescence imaging with theoretically unlimited resolution. Proceedings of the National Academy of Sciences of the United States of America 102, 13081 (2005).
10. Heintzmann, R. & Huser, T. Super-Resolution Structured Illumination Microscopy. Chemical Reviews 117, 13890-13908 (2017).
11. Denkova, D., Ploschner, M., Das, M., Parker, L. M., Zheng, X., Lu, Y., Orth, A., Packer, N. H. & Piper, J. A. 3D sub-diffraction imaging in a conventional confocal configuration by exploiting super-linear emitters. Nat. Commun. 10, 3695 (2019).
12. Liu, Y., Wang, F., Lu, H., Fang, G., Wen, S., Chen, C., Shan, X., Xu, X., Zhang, L., Stenzel, M. & Jin, D. Super-Resolution Mapping of Single Nanoparticles inside Tumor Spheroids. Small 16, 1905572 (2020).
13. Marciniak, L., Bednarkiewicz, A. & Elzbieciak, K. NIR-NIR photon avalanche based luminescent thermometry with Nd3+ doped nanoparticles. Journal of Materials Chemistry C 6, 7568-7575 (2018).
14. Pickel, A. D., Teitelboim, A., Chan, E. M., Borys, N. J., Schuck, P. J. & Dames, C. Apparent self-heating of individual upconverting nanoparticle thermometers. Nat. Commun. 9, 4907 (2018).
15. Lay, A., Sheppard, O. H., Siefe, C., McLellan, C. A., Mehlenbacher, R. D., Fischer, S., Goodman, M. B. & Dionne, J. A. Optically Robust and Biocompatible Mechanosensitive Upconverting Nanoparticles. ACS Central Science 5, 1211-1222 (2019).
16. Xie, P. & Gosnell, T. R. Room-temperature upconversion fiber laser tunable in the red, orange, green, and blue spectral regions. Opt. Lett. 20, 1014-1016 (1995).
17. Guy, S., Joubert, M. F. & Jacquier, B. Photon avalanche and the mean-field approximation. Phys. Rev. B 55, 8240-8248 (1997).
18. Deng, H., Yang, S., Xiao, S., Gong, H.-M. & Wang, Q.-Q. Controlled Synthesis and Upconverted Avalanche Luminescence of Cerium(III) and Neodymium(III) Orthovanadate Nanocrystals with High Uniformity of Size and Shape. Journal of the American Chemical Society 130, 2032-2040 (2008).
19. Wang, Q.-Q., Han, J.-B., Guo, D.-L., Xiao, S., Han, Y.-B., Gong, H.-M. & Zou, X.-W. Highly Efficient Avalanche Multiphoton Luminescence from Coupled Au Nanowires in the Visible Region. Nano Lett. 7, 723-728 (2007).
20. Ma, Z., Yu, Y., Shen, S., Dai, H., Yao, L., Han, Y., Wang, X., Han, J.-B. & Li, L. Origin of the Avalanche-Like Photoluminescence from Metallic Nanowires. Scientific Reports 6, 18857 (2016).
21. Liu, Y., Lu, Y., Yang, X., Zheng, X., Wen, S., Wang, F., Vidal, X., Zhao, J., Liu, D., Zhou, Z., Ma, C., Zhou, J., Piper, J. A., Xi, P. & Jin, D. Amplified stimulated emission in upconversion nanoparticles for super-resolution nanoscopy. Nature 543, 229-233 (2017).
22. Levy, E. S., Tajon, C. A., Bischof, T. S., Iafrati, J., Fernandez-Bravo, A., Garfield, D. J., Chamanzar, M., Maharbiz, M. M., Sohal, V. S., Schuck, P. J., Cohen, B. E. & Chan, E. M. Energy-Looping Nanoparticles: Harnessing Excited-State Absorption for Deep-Tissue Imaging. ACS Nano 10, 8423-8433 (2016).
23. Fernandez-Bravo, A., Yao, K., Barnard, E. S., Borys, N. J., Levy, E. S., Tian, B., Tajon, C. A., Moretti, L., Altoe, M. V., Aloni, S., Beketayev, K., Scotognella, F., Cohen, B. E., Chan, E. M. & Schuck, P. J. Continuous-wave upconverting nanoparticle microlasers. Nat. Nanotechnol. 13, 572-577 (2018).
24. Si, X., Li, Z., Qu-Quan, W., Hong, D. & Shi-He, Y. Energy Transfer and Avalanche Upconversion of NdxY1-xVO4 Nanocrystals. Chin. Phys. Lett. 26, 124209 (2009).
25. Bednarkiewicz, A. & Strek, W. Laser-induced hot emission in Nd3/Yb3:YAG nanocrystallite ceramics. J. Phys. D: Appl. Phys. 35, 2503-2507 (2002).
26. Dwivedi, Y., Bahadur, A. & Rai, S. B. Optical avalanche in Ho:Yb:Gd2O3 nanocrystals. J. Appl. Phys. 110, 043103 (2011).
27. Wang, G., Peng, Q. & Li, Y. Luminescence Tuning of Upconversion Nanocrystals. Chemistry—A European Journal 16, 4923-4931 (2010).
28. Zhou, B., Shi, B., Jin, D. & Liu, X. Controlling upconversion nanocrystals for emerging applications. Nat. Nanotechnol. 10, 924-936 (2015).
29. Tian, B., Fernandez-Bravo, A., Najafiaghdam, H., Torquato, N. A., Altoe, M. V. P., Teitelboim, A., Tajon, C. A., Tian, Y., Borys, N. J., Barnard, E. S., Anwar, M., Chan, E. M., Schuck, P. J. & Cohen, B. E. Low irradiance multiphoton imaging with alloyed lanthanide nanocrystals. Nat. Commun. 9, 3082 (2018).
30. Tajon, C. A., Yang, H., Tian, B., Tian, Y., Ercius, P., Schuck, P. J., Chan, E. M. & Cohen, B. E. Photostable and efficient upconverting nanocrystal-based chemical sensors. Optical Materials 84, 345-353 (2018).
31. Bünzli, J.-C. G. & Piguet, C. Taking advantage of luminescent lanthanide ions. Chem. Soc. Rev. 34, 1048-1077 (2005).
32. Gnach, A., Lipinski, T., Bednarkiewicz, A., Rybka, J. & Capobianco, J. A. Upconverting nanoparticles: assessing the toxicity. Chem. Soc. Rev. 44, 1561-1584 (2015).
33. Gargas, D. J., Chan, E. M., Ostrowski, A. D., Aloni, S., Altoe, M. V. P., Barnard, E. S., Sanii, B., Urban, J. J., Milliron, D. J., Cohen, B. E. & Schuck, P. J. Engineering bright sub-10-nm upconverting nanocrystals for single-molecule imaging. Nat. Nanotechnol. 9, 300 (2014).
34. Fischer, S., Bronstein, N. D., Swabeck, J. K., Chan, E. M. & Alivisatos, A. P. Precise Tuning of Surface Quenching for Luminescence Enhancement in Core-Shell Lanthanide-Doped Nanocrystals. Nano Lett. 16, 7241-7247 (2016).
35. Johnson, N. J. J., He, S., Diao, S., Chan, E. M., Dai, H. & Almutairi, A. Direct Evidence for Coupled Surface and Concentration Quenching Dynamics in Lanthanide-Doped Nanocrystals. Journal of the American Chemical Society 139, 3275-3282 (2017).
36. Liu, Q., Zhang, Y., Peng, C. S., Yang, T., Joubert, L.-M. & Chu, S. Single upconversion nanoparticle imaging at sub-10 W cm−2 irradiance. Nat. Photonics 12, 548-553 (2018).
37. Chen, X., Jin, L., Kong, W., Sun, T., Zhang, W., Liu, X., Fan, J., Yu, S. F. & Wang, F. Confining energy migration in upconversion nanoparticles towards deep ultraviolet lasing. Nat. Commun. 7, 10304 (2016).
38. Wang, F., Deng, R., Wang, J., Wang, Q., Han, Y., Zhu, H., Chen, X. & Liu, X. Tuning upconversion through energy migration in core-shell nanoparticles. Nat. Mater. 10, 968-973 (2011).
39. Gamelin, D. R., Lüthi, S. R. & Güdel, H. U. The Role of Laser Heating in the Intrinsic Optical Bistability of Yb3+-Doped Bromide Lattices. The Journal of Physical Chemistry B 104, 11045-11057 (2000).
40. Butcher, J. C. Numerical Methods for Ordinary Differential Equations. (Wiley, 2016).
41. Goldner, P. & Pelle, F. Photon avalanche fluorescence and lasers. Optical Materials 5, 239-249 (1996).
42. Joubert, M. F., Guy, S. & Jacquier, B. Model of the photon-avalanche effect. Phys. Rev. B 48, 10031-10037 (1993).
43. Hong, G., Diao, S., Chang, J., Antaris, A. L., Chen, C., Zhang, B., Zhao, S., Atochin, D. N., Huang, P. L., Andreasson, K. I., Kuo, C. J. & Dai, H. Through-skull fluorescence imaging of the brain in a new near-infrared window. Nat. Photonics 8, 723-730 (2014).
44. Ostrowski, A. D., Chan, E. M., Gargas, D. J., Katz, E. M., Han, G., Schuck, P. J., Milliron, D. J. & Cohen, B. E. Controlled Synthesis and Single-Particle Imaging of Bright, Sub-10 nm Lanthanide-Doped Upconverting Nanocrystals. ACS Nano 6, 2686-2692 (2012).
45. Hossan, M. Y., Hor, A., Luu, Q., Smith, S. J., May, P. S. & Berry, M. T. Explaining the Nanoscale Effect in the Upconversion Dynamics of β-NaYF4:Yb3+, Er3+Core and Core-Shell Nanocrystals. The Journal of Physical Chemistry C 121, 16592-16606 (2017).
46. Teitelboim, A., Tian, B., Garfield, D. J., Fernandez-Bravo, A., Gotlin, A. C., Schuck, P. J., Cohen, B. E. & Chan, E. M. Energy Transfer Networks within Upconverting Nanoparticles Are Complex Systems with Collective, Robust, and History-Dependent Dynamics. The Journal of Physical Chemistry C 123, 2678-2689 (2019).
47. Chan, E. M., Gargas, D. J., Schuck, P. J. & Milliron, D. J. Concentrating and Recycling Energy in Lanthanide Codopants for Efficient and Spectrally Pure Emission: The Case of NaYF4:Er3+/Tm3+ Upconverting Nanocrystals. The Journal of Physical Chemistry B 116, 10561-10570 (2012).
48. Corle, T. R. & Kino, G., S. Confocal Scanning Optical Microscopy and Related Imaging Systems. (Academic Press, 1996).
49. Chen, C., Wang, F., Wen, S., Su, Q. P., Wu, M. C. L., Liu, Y., Wang, B., Li, D., Shan, X., Kianinia, M., Aharonovich, I., Toth, M., Jackson, S. P., Xi, P. & Jin, D. Multi-photon near-infrared emission saturation nanoscopy using upconversion nanoparticles. Nat. Commun. 9, 3290 (2018).
50. Pichaandi, J., Boyer, J.-C., Delaney, K. R. & van Veggel, F. C. J. M. Two-Photon Upconversion Laser (Scanning and Wide-Field) Microscopy Using Ln3+-Doped NaYF4 Upconverting Nanocrystals: A Critical Evaluation of their Performance and Potential in Bioimaging. The Journal of Physical Chemistry C 115, 19054-19064 (2011).
51. Auzel, F., Chen, Y. & Meichenin, D. Room temperature photon avalanche up-conversion in Er-doped ZBLAN glass. J. Lumin. 60-61, 692-694 (1994).
52. Auzel, F. & Chen, Y. Photon avalanche luminescence of Er³⁺ ions in LiYF₄ crystal. J. Lumin. 65, 45-56 (1995).
53. Gomes, A. S. L., Maciel, G. S., de Araújo, R. E., Acioli, L. H. & de Araújo, C. B. Diode pumped avalanche upconversion in Pr³⁺-doped fibers. Optics Communications 103, 361-364 (1993).
54. Martin, I. R., Rodriguez, V. D., Guyot, Y., Guy, S., Boulon, G. & Joubert, M. F. Room temperature photon avalanche upconversion in Tm³⁺-doped fluoroindate glasses. J. Phys.: Condens. Matter 12, 1507-1516 (2000).
55. Li, Y., Wang, T., Ren, W., Han, J., Yin, Z., Qiu, J., Yang, Z. & Song, Z. BiOCl:Er³⁺ Nanosheets with Tunable Thickness for Photon Avalanche Phosphors. ACS Applied Nano Materials 2, 7652-7660 (2019).
56. Garfield, D. J., Borys, N. J., Hamed, S. M., Torquato, N. A., Tajon, C. A., Tian, B., Shevitski, B., Barnard, E. S., Suh, Y. D., Aloni, S., Neaton, J. B., Chan, E. M., Cohen, B. E. & Schuck, P. J. Enrichment of molecular antenna triplets amplifies upconverting nanoparticle emission. Nat. Photonics 12, 402-407 (2018).
57. Liu, Y., Teitelboim, A., Fernandez-Bravo, A., Yao, K., Altoe, M. V. P., Aloni, S., Zhang, C., Cohen, B. E., Schuck, P. J. & Chan, E. M. Controlled Assembly of Upconverting Nanoparticles for Low-Threshold Microlasers and Their Imaging in Scattering Media. ACS Nano 14, 1508-1519 (2020).
58. Fernandez-Bravo, A., Wang, D., Barnard, E. S., Teitelboim, A., Tajon, C., Guan, J., Schatz, G. C., Cohen, B. E., Chan, E. M., Schuck, P. J. & Odom, T. W. Ultralow-threshold, continuous-wave upconverting lasing from subwavelength plasmons. Nat. Mater. 18, 1172-1176 (2019).
59. Kilbane, J. D., Chan, E. M., Monachon, C., Borys, N. J., Levy, E. S., Pickel, A. D., Urban, J. J., Schuck, P. J. & Dames, C. Far-field optical nanothermometry using individual sub-50 nm upconverting nanoparticles. Nanoscale 8, 11611-11616 (2016).
60. Zhai, Y., Zhou, Y., Yang, X., Wang, F., Ye, W., Zhu, X., She, D., Lu, W. D. & Han, S.-T. Near infrared neuromorphic computing via upconversion-mediated optogenetics. Nano Energy 67, 104262 (2020).
61. Bradac, C., Johnsson, M. T., Breugel, M. v., Baragiola, B. Q., Martin, R., Juan, M. L., Brennen, G. K. & Volz, T. Room-temperature spontaneous superradiance from single diamond nanocrystals. Nat. Commun. 8, 1205 (2017).
62. Asenjo-Garcia, A., Kimble, H. J. & Chang, D. E. Optical waveguiding by atomic entanglement in multilevel atom arrays. Proceedings of the National Academy of Sciences 116, 25503 (2019).
63. Joubert, M.-F., Guy, S., Jacquier, B. & Linares, C. The photon-avalanche effect: review, model and application. Optical Materials 4, 43-49 (1994).
64. Guy, S., Joubert, M. & Jacquier, B. Photon avalanche and the mean-field approximation. Physical Review B 55, 8240 (1997).
65. Villanueva-Delgado, P., Biner, D. & Krämer, K. Judd-Ofelt analysis of β-NaGdF4:Yb3+, Tm3+ and β-NaGdF4:Er3+ single crystals. Journal of luminescence 189, 84-90 (2017).
66. Carnall, W., Crosswhite, H. & Crosswhite, H. M. Energy level structure and transition probabilities in the spectra of the trivalent lanthanides in LaF₃. (Argonne National Lab.(ANL), Argonne, IL (United States), 1978).
67. Armagan, G., Buoncristiani, A. & Di Bartolo, B. Excited state dynamics of thulium ions in Yttrium Aluminum Garnets. Optical Materials 1, 11-20 (1992).
68. Shaw, L., Chang, R. & Djeu, N. Measurement of up-conversion energy-transfer probabilities in Ho:Y3Al5O12 and Tm:Y3Al5O12. Physical Review B 50, 6609 (1994).
69. Basiev, T., Orlovskii, Y. V., Pukhov, K. & Auzel, F. Multiphonon relaxation of the energy of electronic excitation in optical crystals doped with rare-earth ions. Laser Physics 7, 1139-1152 (1997).
70. Miyakawa, T. & Dexter, D. Phonon sidebands, multiphonon relaxation of excited states, and phonon-assisted energy transfer between ions in solids. Physical Review B 1, 2961 (1970).
71. Fischer, S., Bronstein, N. D., Swabeck, J. K., Chan, E. M. & Alivisatos, A. P. Precise tuning of surface quenching for luminescence enhancement in core-shell lanthanide-doped nanocrystals. Nano letters 16, 7241-7247 (2016).
72. Goldner, P. & Pelle, F. Photon avalanche fluorescence and lasers. Optical Materials 5, 239-249, doi:https://doi.org/10.1016/0925-3467(96)00003-1 (1996).
73. Peterka, P., Kasik, I., Dhar, A., Dussardier, B. & Blanc, W. Theoretical modeling of fiber laser at 810 nm based on thulium-doped silica fibers with enhanced 3 H 4 level lifetime. Optics express 19, 2773-2781 (2011).
74. Auzel, F. & Pellé, F. Bottleneck in multiphonon nonradiative transitions. Physical Review B 55, 11006 (1997).
75. Chan, E. M. Combinatorial approaches for developing upconverting nanomaterials: high-throughput screening, modeling, and applications. Chem. Soc. Rev. 44, 1653-1679, doi:10.1039/C4C500205A (2015).
76. Jackson, S. D. & King, T. A. Theoretical modeling of Tm-doped silica fiber lasers. Journal of lightwave technology 17, 948 (1999).
77. Joubert, M.-F. Photon avalanche upconversion in rare earth laser materials. Optical Materials 11, 181-203, doi:https://doi.org/10.1016/S0925-3467(98)00043-3 (1999).
78. Bednarkiewicz, A. & Strek, W. Laser-induced hot emission in Nd3+/Yb3+:YAG nanocrystallite ceramics. Journal of Physics D: Applied Physics 35, 2503 (2002).
79. Deng, H. et al. Additive-mediated splitting of lanthanide orthovanadate nanocrystals in water: morphological evolution from rods to sheaves and to spherulites. Crystal Growth and Design 8, 4432-4439 (2008).
80. Deng, H., Yang, S., Xiao, S., Gong, H.-M. & Wang, Q.-Q. Controlled synthesis and upconverted avalanche luminescence of cerium (III) and neodymium (III) orthovanadate nanocrystals with high uniformity of size and shape. Journal of the American Chemical Society 130, 2032-2040 (2008).
81. Si, X., Li, Z., Qu-Quan, W., Hong, D. & Shi-He, Y. Energy Transfer and Avalanche Upconversion of NdxY1xVO4 Nanocrystals. Chinese Physics Letters 26, 124209 (2009).
82. Joshi, C. & Rai, S. Structural, thermal, and optical properties of Pr3+/Yb3+ co-doped oxyhalide tellurite glasses and its nano-crystalline parts. Solid state sciences 14, 997-1003 (2012).
83. Joshi, C., Rai, R. & Rai, S. Structural, thermal, and optical properties of Er3+/Yb3+ co-doped oxyhalide tellurite glasses, glass-ceramics and ceramics. Journal of Quantitative Spectroscopy and Radiative Transfer 113, 397-404 (2012).
84. Babu, P. et al. Photon avalanche upconversion in Ho3+-Yb3+ co-doped transparent oxyfluoride glass-ceramics. Chemical Physics Letters 600, 34-37 (2014).
85. Marciniak, L., Stefanski, M., Tomala, R., Hreniak, D. & Strek, W. Synthesis and up-conversion luminescence of Er3+ and Yb3+ codoped nanocrystalline tetra-(KLaP4O12) and pentaphosphates (LaP5O14). The Journal of Chemical Physics 143, 094701 (2015).
86. Rathaiah, M. et al. Photon avalanche upconversion in Ho3+-doped gallium nano-garnets. Optical Materials 39, 16-20 (2015).
87. Levy, E. S. et al. Energy-looping nanoparticles: harnessing excited-state absorption for deep-tissue imaging. ACS nano 10, 8423-8433 (2016).
88. Dwivedi, Y., Bahadur, A. & Rai, S. Optical avalanche in Ho:Yb:Gd2O3 nanocrystals. Journal of Applied Physics 110, 043103 (2011).
89. Liu, Y. et al. Amplified stimulated emission in upconversion nanoparticles for super-resolution nanoscopy. Nature 543, 229-233, doi:10.1038/nature21366 (2017).
90. Wang, F., Yang, B., Yu, Q., Liu, D. & Ma, W. Cooperative upconversion luminescence of Er3+ in Gd2O3-xSx phosphor. Spectrochimica Acta Part A: Molecular and Biomolecular Spectroscopy 190, 312-317 (2018).
91. Marciniak, L., Bednarkiewicz, A. & Elzbieciak, K. NIR-NIR photon avalanche based luminescent thermometry with Nd3+ doped nanoparticles. Journal of Materials Chemistry C 6, 7568-7575 (2018).
92. Bednarkiewicz, A., Chan, E. M., Kotulska, A., Marciniak, L. & Prorok, K. Photon avalanche in lanthanide doped nanoparticles for biomedical applications: super-resolution imaging. Nanoscale Horizons 4, 881-889 (2019).
93. Li, Y. et al. BiOCl:Er3+ nanosheets with tunable thickness for photon avalanche phosphors. ACS Applied Nano Materials 2, 7652-7660 (2019).
94. Denkova, D. et al. 3D sub-diffraction imaging in a conventional confocal configuration by exploiting super-linear emitters. Nature communications 10, 1-12 (2019).
95. Plöschner, M. et al. Simultaneous super-linear excitation-emission and emission depletion allows imaging of upconversion nanoparticles with higher sub-diffraction resolution. Optics Express 28, 24308-24326 (2020).
96. Liu, B. et al. Upconversion nonlinear structured illumination microscopy. Nano Letters (2020).
97. Schermelleh, L. et al. Super-resolution microscopy demystified. Nature cell biology 21, 72-84 (2019).
98. De Luca, G. M. et al. Re-scan confocal microscopy: scanning twice for better resolution. Biomedical optics express 4, 2644-2656 (2013).
99. Juette, M. F. et al. Three-dimensional sub-100 nm resolution fluorescence microscopy of thick samples. Nature methods 5, 527-529 (2008).
100. Schoen, I., Ries, J., Klotzsch, E., Ewers, H. & Vogel, V. Binding-activated localization microscopy of DNA structures. Nano letters 11, 4008-4011 (2011).
101. Szczurek, A. et al. Imaging chromatin nanostructure with binding-activated localization microscopy based on DNA structure fluctuations. Nucleic acids research 45, e56-e56 (2017).
102. York, A. G. et al. Instant super-resolution imaging in live cells and embryos via analog image processing. Nature methods 10, 1122-1126 (2013).
103. Demmerle, J. et al. Strategic and practical guidelines for successful structured illumination microscopy. Nature protocols 12, 988-1010 (2017).
104. Gustafsson, M. G. et al. Three-dimensional resolution doubling in wide-field fluorescence microscopy by structured illumination. Biophysical journal 94, 4957-4970 (2008).
105. Heintzmann, R. & Huser, T. Super-Resolution Structured Illumination Microscopy. Chemical Reviews 117, 13890-13908, doi:10.1021/acs.chemrev.7b00218 (2017).
106. Sheppard, C. J., Mehta, S. B. & Heintzmann, R. Superresolution by image scanning microscopy using pixel reassignment. Optics letters 38, 2889-2892 (2013).
107. Eggeling, C., Willig, K. I., Sahl, S. J. & Hell, S. W. Lens-based fluorescence nanoscopy. Quarterly reviews of biophysics 48, 178-243 (2015).
108. Huff, J. The Airyscan detector from ZEISS: confocal imaging with improved signal-to-noise ratio and super-resolution. Nature methods 12, i-ii (2015).
109. Korobchevskaya, K., Lagerholm, B. C., Colin-York, H. & Fritzsche, M. in Photonics. 41 (Multidisciplinary Digital Publishing Institute).
110. Jungmann, R. et al. Quantitative super-resolution imaging with qPAINT. Nature methods 13, 439-442 (2016).
111. Schnitzbauer, J., Strauss, M. T., Schlichthaerle, T., Schueder, F. & Jungmann, R. Super-resolution microscopy with DNA-PAINT. Nature protocols 12, 1198 (2017).
112. Dertinger, T., Colyer, R., Iyer, G., Weiss, S. & Enderlein, J. Fast, background-free, 3D super-resolution optical fluctuation imaging (SOFI). Proceedings of the National Academy of Sciences 106, 22287-22292 (2009).
113. Gustafsson, N. et al. Fast live-cell conventional fluorophore nanoscopy with ImageJ through super-resolution radial fluctuations. Nature communications 7, 1-9 (2016).
114. Chen, B.-C. et al. Lattice light-sheet microscopy: imaging molecules to embryos at high spatiotemporal resolution. Science 346 (2014).
115. Chang, J.-B. et al. Iterative expansion microscopy. Nature methods 14, 593-599 (2017).
116. Chen, F., Tillberg, P. W. & Boyden, E. S. Expansion microscopy. Science 347, 543-548 (2015).
117. Liu, W. et al. Breaking the Axial Diffraction Limit: A Guide to Axial Super-Resolution Fluorescence Microscopy. Laser & Photonics Reviews 12, 1700333 (2018).

1-20. (canceled)

21. A nanoparticle, comprising:
thulium doped nanocrystals configured to induce photon avalanching.

22. The nanoparticle of claim 21, wherein a near infrared excitation wavelength of the nanocrystals is greater than about 1064 nm.

23. The nanoparticle of claim 22, wherein the near infrared excitation wavelength is between about 1400 nm to about 1490 nm.

24. The nanoparticle of claim 21, further comprising at least one passivated shell surrounding the nanocrystals.

25. The nanoparticle of claim 21, wherein a Yb³⁺ sensitizer is omitted.

26. The nanoparticle of claim 21, wherein the nanoparticle includes 100% of the thulium doped nanocrystals.

27. The nanoparticle of claim 21, wherein the nanoparticle extends for less than 100 nanometers in a three-dimensional space.

28. The nanoparticle of claim 21, wherein the nanoparticle includes at least 4% of the thulium doped nanocrystals.

29. The nanoparticle of claim 21, wherein the nanoparticle includes at least 8% of the thulium doped nanocrystals.

30. A method for inducing photon avalanching, comprising:
utilizing a nanoparticle having thulium doped nanocrystals

31. The method of claim 30, wherein a near infrared excitation wavelength of the nanocrystals is greater than about 1064 nm.

32. The method of claim 31, wherein the near infrared excitation wavelength is between about 1400 nm to about 1490 nm.

33. The method of claim 30, further comprising at least one passivated shell surrounding the nanocrystals.

34. The method of claim 30, wherein a Yb³⁺ sensitizer is omitted.

35. The method of claim 30, wherein the nanoparticle includes 100% of the thulium doped nanocrystals.

36. The method of claim 30, wherein the nanoparticle extends for less than 100 nanometers in a three-dimensional space.

37. The method of claim 30, wherein at least 4% of the thethulium doped nanocrystals is utilized.

38. The method of claim 30, wherein at least 8% of the thethulium doped nanocrystals is utilized.
